(19) United States
(12) Patent Application Publication
(10) Pub. No.: US 2014/0312834 A1
(43) Pub. Date: Oct. 23, 2014

(54) WEARABLE IMPACT MEASUREMENT DEVICE WITH WIRELESS POWER AND DATA COMMUNICATION

(71) Applicants: Yuji Tanabe, Palo Alto, CA (US); Ada Poon, Palo Alto, CA (US); David B. Camarillo, Stanford, CA (US); Lyndia Chun Wu, Palo Alto, CA (US); Alex Yeh, Palo Alto, CA (US)

(72) Inventors: Yuji Tanabe, Palo Alto, CA (US); Ada Poon, Palo Alto, CA (US); David B. Camarillo, Stanford, CA (US); Lyndia Chun Wu, Palo Alto, CA (US); Alex Yeh, Palo Alto, CA (US)

(21) Appl. No.: 14/256,722

(22) Filed: Apr. 18, 2014

Related U.S. Application Data
(60) Provisional application No. 61/814,206, filed on Apr. 20, 2013.
(60) Provisional application No. 61/858,079, filed on Jul. 24, 2013.

(51) Int. Cl. H02J 7/02; H01Q 1/27; H01Q 5/00

(52) U.S. Cl. CPC H02J 7/025; H01Q 5/0027; H01Q 1/273
USPC 320/108; 343/718

(57) ABSTRACT

Described herein is a wearable device for impact measurement with wireless power and communication capability. The wearable device includes a base member configured for placement on a human body, an electronic board affixed to the base member, and a rechargeable battery affixed to the base member. The device also includes a dual-band antenna printed on the electronic board for wireless power and data communication. Also provided are methods for charging the wearable device with different power sources.

### CROSS REFERENCE TO RELATED APPLICATIONS

This application claims the benefit of U.S. Provisional Application Ser. No. 61/814,206 filed on Apr. 20, 2013 and U.S. Provisional Application Ser. No. 61/858,079 filed on Jul. 24, 2013, the disclosures of which are incorporated herein by reference in their entireties.

### FIELD OF THE DISCLOSURE

The present disclosure, in general, relates to wearable devices for detecting impacts in sports, healthcare, and other applications. In particular, the disclosure describes wearable devices with wireless power and data communication capability and methods of wirelessly powering and communicating with the wearable devices. The designs and methods disclosed herein are applicable to wearable devices used in applications other than impact measurement.

### BACKGROUND

The following discussion of the background of the disclosure is merely provided to aid the reader in understanding the disclosure and is not admitted to describe or constitute prior art to the present disclosure.

The Centers for Disease Control and Prevention (CDC) estimates over 300,000 sports related concussions occurring each year. In 2009, the State of Washington passed the Lystedt law, named after Zackery Lystedt who suffered a brain hemorrhage and was paralyzed after receiving two severe head blows during a junior high football game. While such catastrophic events are rare, sustaining a single concussion increases one's risk of re-injury by 2 to 6 times with associated delayed recovery of cognitive, memory, and mood symptoms. Therefore, it is important to accurately identify athletes that have been concussed to prevent re-injury. The Lystedt law, now ratified in 42 states, requires youth athletes to be removed from play whenever a head injury is suspected to have occurred. Unfortunately, concussion is an “invisible” injury and often goes undetected. The lack of an objective injury measurement solution is further complicated by a sports culture that often promotes playing through injury. To protect young athletes, there is a need for an objective diagnostic tool to aid parents, coaches, and clinicians to make the decision to remove injured athletes from play.

### SUMMARY

The present disclosure provides, in some embodiments, a wearable device attached to a human subject, such as a mouthguard, for detecting the impact on the human subject during an event. The wearable device includes an electronic circuitry for motion sensing, data processing, and data transfer. A rechargeable battery can be used to power the wearable device. To avoid the corrosion of contact leads for battery charging by saliva, wireless power and data communication can be used such that contact leads are not necessary, and the whole electronic circuitry can be hermetically sealed. The designs and methods disclosed herein are applicable to wearable devices for other applications where wireless power and data communication may be used.

In some embodiments, a wearable device includes (1) a base member configured for placement on a human subject; (2) a rechargeable battery affixed to the base member; (3) an electronic board affixed to the base member; and (4) a dual-band antenna printed on the electronic board for wireless power and data communication.

In some embodiments, the dual-band antenna of the wearable device is an asymmetric dipole antenna including a dipole arm and a loop connected to the dipole arm.

In some embodiments, the dual-band antenna of the wearable device includes two monopole elements and a matching component connecting the two monopole elements.

In some embodiments, at least a part of the dual-band antenna of the wearable device is circumferential.

In some embodiments, the dual-band antenna of the wearable device is configured for both near field and far field communications.

In some embodiments, an operating frequency of a first band of the dual-band antenna of the wearable device is at least 100 times higher than an operating frequency of a second band of the dual-band antenna.

In some embodiments, a first band of the dual-band antenna of the wearable device is at least one of a Bluetooth, ZigBee, Wireless Fidelity (Wi-Fi), Worldwide Interoperability for Microwave Access (WiMAX), and Ultra-Wideband (UWB) operating bands.

In some embodiments, a second band of the dual-band antenna of the wearable device is at least one of a near field communication (NFC) and an inductive power transfer standard, such as Qi, operating bands.

In some embodiments, the electronic board of the wearable device includes at least one sensor configured for motion measurement.

In some embodiments, the electronic board of the wearable device further includes a circuit for indicating at least one of a power level, a vital sign, a temperature level, and an alarm signal.

In some embodiments, the electronic board of the wearable device further includes a processor and a memory in electronic communication with the processor, the memory comprising program code configured to process sensor data.

In some embodiments, the electronic board and the rechargeable battery of the wearable device are hermetically sealed.

In some embodiments, the base member of the wearable device has a generally U-shaped form defining a channel to receive an upper or lower row of teeth of a human subject.

In some embodiments, the wearable device further includes a daughter electronic board including a proximity sensor configured to measure a location of the wearable device relative to a human subject.

In some embodiments, the wearable device further includes a daughter electronic board including an additional antenna for at least one of wireless power and data communication.

The present disclosure also provides, in some embodiments, a method of wirelessly powering a wearable device including: (1) providing a wearable device including (a) a base member configured for placement on a human body; (b) a rechargeable battery affixed to the base member; (c) an electronic board affixed to the base member; and (d) a dual-band antenna printed on the electronic board for wireless power and data communication; (2) providing a charging station for wireless communication with the wearable device, the charging station including a power source and an antenna configured to communicate with the wearable device; (3) transmitting wireless signals using the antenna on the charging station; (4) receiving the wireless signals using the dual-band antenna on the wearable device; and (5) charging the rechargeable battery on the wearable device with the wireless signals received.

In some embodiments, the charging station includes at least one of a smartphone, a charging box, a wearable pack, a body garment, a helmet patch, a locker, and a mat on a sports field.

In some embodiments, the power source of the charging station includes at least one of a battery, an alternative current power supply, a universal serial bus (USB) device, a photovoltaic cell, a piezoelectric power generator, an electromagnetic power generator, a chemical battery using human saliva, a thermoelectric power generator, and an acoustic energy harvesting device.

In some embodiments, the antenna on the charging station is an antenna array.

In some embodiments, the antenna on the charging station is matched with the dual-band antenna on the wearable device for power transfer.

Other aspects and embodiments of the disclosure are also contemplated. The foregoing summary and the following detailed description are not meant to restrict the disclosure to any particular embodiment but are merely meant to describe some embodiments of the disclosure.

### BRIEF DESCRIPTION OF THE DRAWINGS

Provided as embodiments of this disclosure are drawings which illustrate certain aspects by example, and not limitation. For a better understanding of the nature and objects of some embodiments of the disclosure, reference should be made to the following detailed description taken in conjunction with the accompanying drawings, wherein:

FIG. 1 illustrates a mouthguard device for impact measurement including an electronic board and a battery embedded in a base member;

FIG. 2A illustrates a mouthguard device for impact measurement including an electronic board affixed to a base member, the electronic board including an antenna printed on the electronic board;

FIG. 2B illustrates a prototype of a mouthguard device for impact measurement;

FIG. 3 illustrates an electronic board for impact measurement enclosed in a hard case configured as a patch;

FIG. 4 illustrates an electronic board for impact measurement including an antenna and motion sensors;

FIG. 5A illustrates an electronic board for impact measurement with an antenna and motion sensors;

FIG. 5B illustrates the simulated current flow on the electronic board shown in FIG. 5A;

FIG. 6 illustrates a wearable device with a daughter board in addition to a main electronic board;

FIG. 7 illustrates an electronic board with a circumferential near field communication antenna;

FIG. 8 illustrates a device with an indicator signaling device charging status;

FIG. 9 illustrates typical permeability values of different materials;

FIG. 10A illustrates a configuration of charging a wearable device using an external antenna;

FIG. 10B illustrates the power transfer characteristics of the configuration shown in FIG. 10A;

FIG. 11 illustrates simultaneous charging and communication with a plurality of devices using an external antenna array;

FIG. 12 illustrates a random placement of multiple devices on an external antenna array;

FIG. 13 illustrates the power transfer characteristics of the placement shown in FIG. 12;

FIG. 14 illustrates an embodiment where a cellphone is used as an external charging station for charging and communicating with a wearable device, and where the battery charging status is displayed;

FIG. 15 illustrates an embodiment where a charging box is used as an external charging station for charging and communicating with wearable devices;

FIG. 16 illustrates an embodiment where lockers are used as external charging stations for charging and communicating with wearable devices;

FIG. 17 illustrates external charging stations placed on a sports field;

FIG. 18 illustrates embodiments of external charging stations on a referee and a player, respectively;

FIGS. 19A-19D illustrate embodiments of external charging stations affixed on sports equipment and garments;

FIG. 20A and FIG. 20B illustrate external charging stations powered by a solar panel and a USB port, respectively;

FIGS. 21A, 21B, and 21C illustrate embodiments of piezoelectric power generation;

FIGS. 22A-22B illustrate embodiments of electromagnetic power generation;

FIGS. 23A-23C illustrate additional energy harvesting methods;

FIGS. 24A-24C illustrate embodiments of antennas for wireless power and data communication;

FIG. 25 illustrates the simulated current distribution on an asymmetric dipole antenna for wireless power and data communication;

FIG. 26 illustrates the simulated radiation pattern of an asymmetric dipole antenna at the Bluetooth band;

FIG. 27 illustrates the simulated near field communication (NFC) wireless power transfer efficiency at a distance of 20 mm between matched transmitter and receiver antennas;

FIG. 28A illustrates a setup for radiation efficiency measurement;

FIG. 28B illustrates the simulated and measured reflection coefficients of embodiments of an antenna for wireless power and data communication;

FIG. 29 illustrates the simulated and measured radiation efficiencies of embodiments of an antenna for wireless power and data communication;

FIG. 30 illustrates the matching circuit for receiving power using NFC antenna;

FIG. 31 illustrates a setup for power transfer efficiency measurement;

FIG. 32 illustrates the measured power transfer efficiencies of embodiments of an antenna for wireless power and data communication.

Some or all of the figures are schematic representations by way of example; hence, they do not necessarily depict the actual relative sizes or locations of the elements shown. The figures are presented for the purpose of illustrating one or more embodiments with the explicit understanding that they will not be used to limit the scope or the meaning of the claims that follow below.

### DETAILED DESCRIPTION

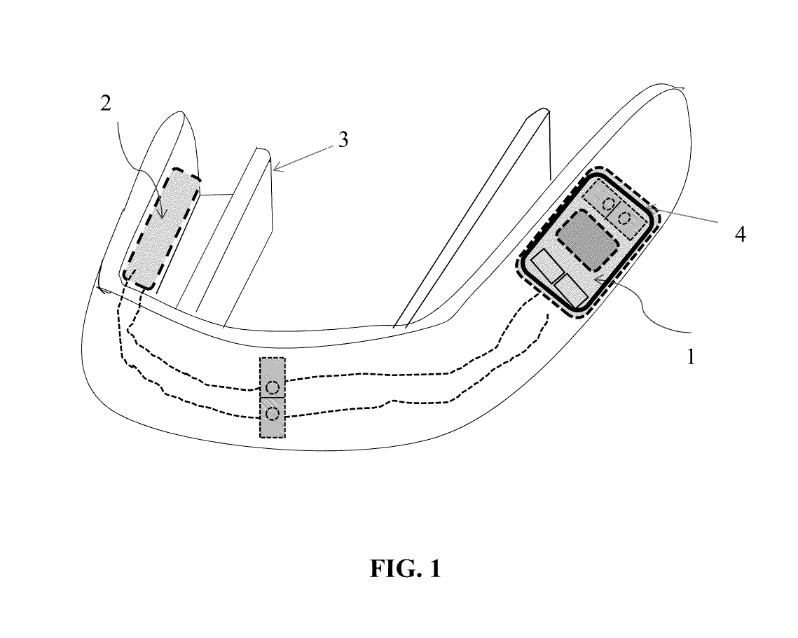

The present disclosure describes a wearable device and the methodology of wirelessly powering and communicating with the wearable device. Certain embodiments of the present disclosure relate to a wearable device that measures impacts on a human subject. The wearable device includes a hermetically sealed electronic board 1 and a hermetically sealed rechargeable battery 2 embedded within or affixed to a base member 3 for attaching to a human subject as shown in FIG. 1. The wearable device can be powered wirelessly without requiring exposed contact leads for charging the rechargeable battery 2. A compact dual-band antenna 4 can be printed on the electronic board 1 for both wireless power and wireless data communication.

According to some embodiments, an external charging station with an external antenna transmits a wireless signal towards a wearable device. The wearable device, including an embedded antenna, picks up the wireless signal and uses it as a power source to charge the battery and power the circuitry on the wearable device. Data can be communicated between the external charging station and the wearable device through the external antenna and the embedded antenna as well.

a. Wearable Impact Measurement Device

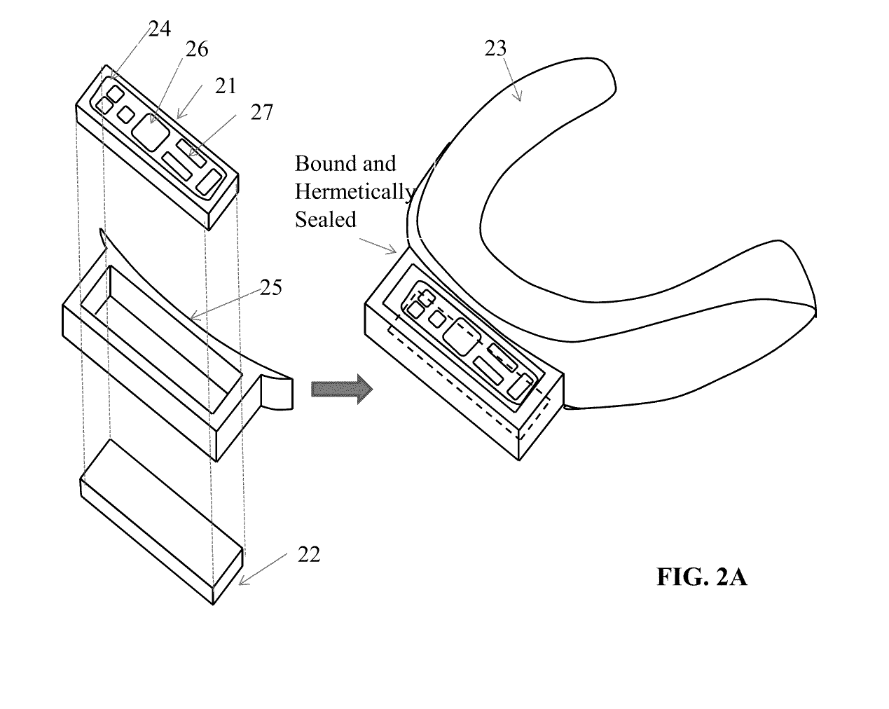

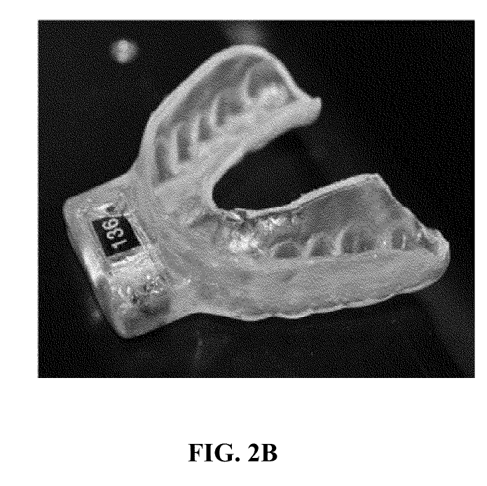

In some embodiments, as shown in FIG. 2A, the wearable device includes (a) a base member 23 configured for placement on a human subject; (b) a rechargeable battery 22 affixed to, housed in, or embedded in the base member 23; and (c) an electronic board 21 affixed to, housed in, or embedded in the base member 23, where the electronic board 21 includes a dual-band antenna 24. The dual-band antenna 24 can be configured to communicate with an external device and receive wireless power to power the circuitry on the wearable device.

i. Base Member

In some embodiments, as illustrated in FIG. 1, the base member 3 of the impact measurement device has a generally U-shaped form defining a channel to receive an upper or lower row of teeth of a human subject. In some embodiments, as illustrated in FIG. 2A, the base member 23 can be shaped as a mouthguard used by athletes.

In some embodiments, the base member having a U-shape is made of biocompatible material. In some embodiments, the base member is long enough to cover at least 6 teeth, 8 teeth, 10 teeth or 12 teeth of a human youth. In some embodiments, the base member is at least about 4 cm long or alternatively at least about 6 or 8 cm long. In some embodiments, the base member includes a channel to receive the teeth, and the channel is at least about 0.4, 0.5, 0.6, 0.7, or 0.8 cm deep.

In some embodiments, the base member can be a tooth patch that is securely attached onto one or more of the human subject's teeth, where the tooth patch includes an accelerometer or other sensors for data collection. In some embodiments, the base member takes the form of an earplug such that it can be placed in an ear.

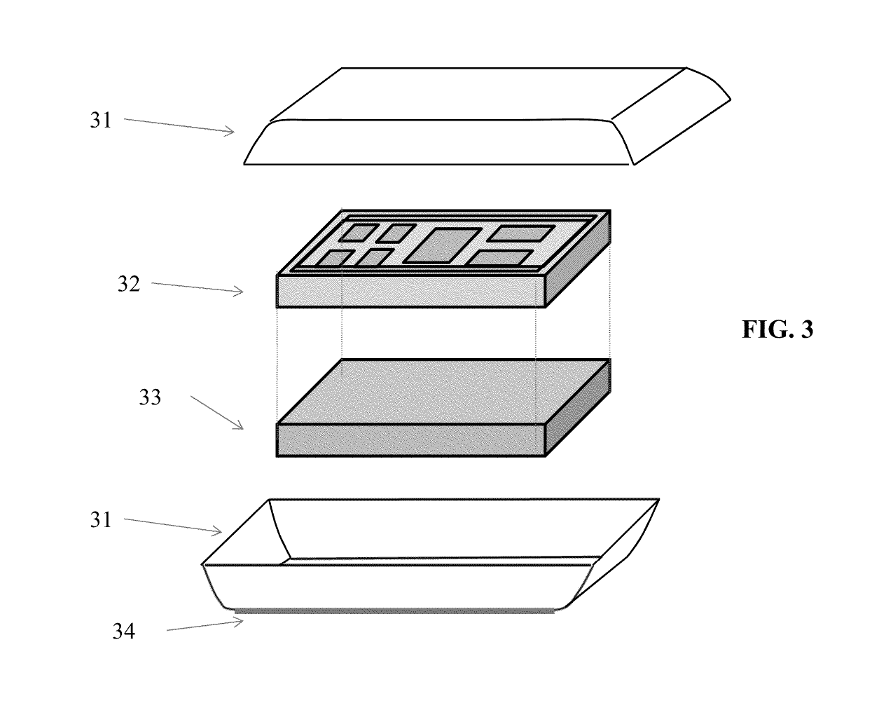

In some embodiments, as shown in FIG. 3, the base member is a hard case 31, which can be used as a patch for affixing the impact measurement device to a portion of the skin or other parts of a human body using, for example, an adhesive 34. The patch can be attached directly to the top of a human head, ear stubs, nose stubs, or any other parts of the head with minimal relative motion between the attachment location and the center of mass of the human head.

Other embodiments of the base member are encompassed by this disclosure. For example, the base member can be configured in the form of, or as part of, sports equipment, garments, implants, or other objects for placement on or implantation within a human body.

ii. Electronic Board

In some embodiments, as illustrated in FIG. 2A, the electronic board 21 of the wearable device is held in a plastic tray 25 affixed to the base member 23, and hermetically sealed to prevent or reduce any fluid ingress into the circuitry and improve robustness of the device.

In some embodiments, as illustrated in FIG. 3, an electronic board 32 and a rechargeable battery 33 are held in the hard case 31, and hermetically sealed to prevent or reduce any fluid ingress into the circuitry and improve the robustness and durability of the device.

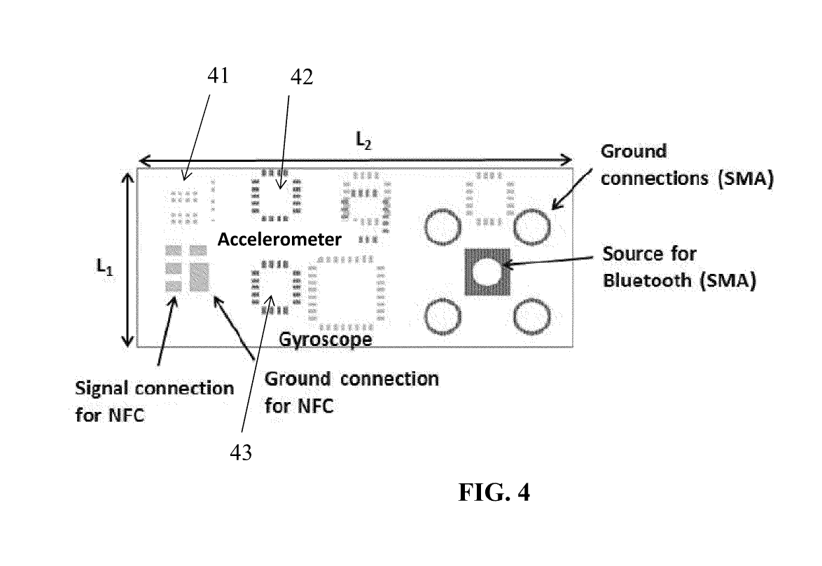

In some embodiments, as illustrated in FIG. 4, an electronic board 41 includes either, or both, a linear acceleration sensor 42, such as an accelerometer, and a rotational velocity sensor 43, such as a gyroscope, which detects motion of the device on a human subject. In some embodiments, the linear acceleration sensor 42 is a multi-axial accelerometer, such as a tri-axial accelerometer or a dual-axial accelerometer. In some embodiments, the rotational velocity sensor 43 is a multi-axial gyroscope, such as a dual-axial gyroscope or a tri-axial gyroscope. In some embodiments, other combinations of one or more single-axial and multi-axial accelerometers and gyroscopes can be used to measure magnitudes and directions of motion.

In some embodiments, as illustrated in FIG. 2A, the electronic board 21 of the wearable device further includes a processor 26 and a memory 27 for sensor data processing and storage. The memory 27 can be any non-transitory computer-readable storage medium storing program code for implementing software methodologies described in the present disclosure. Other processing units and computer software can also be embedded in the device.

In some embodiments, the electronic board further includes a circuit configured to detect false positive movement from, for example, chewing, dislodging, dropping, and throwing. In some embodiments, the device has an indicator to signal false positive movement.

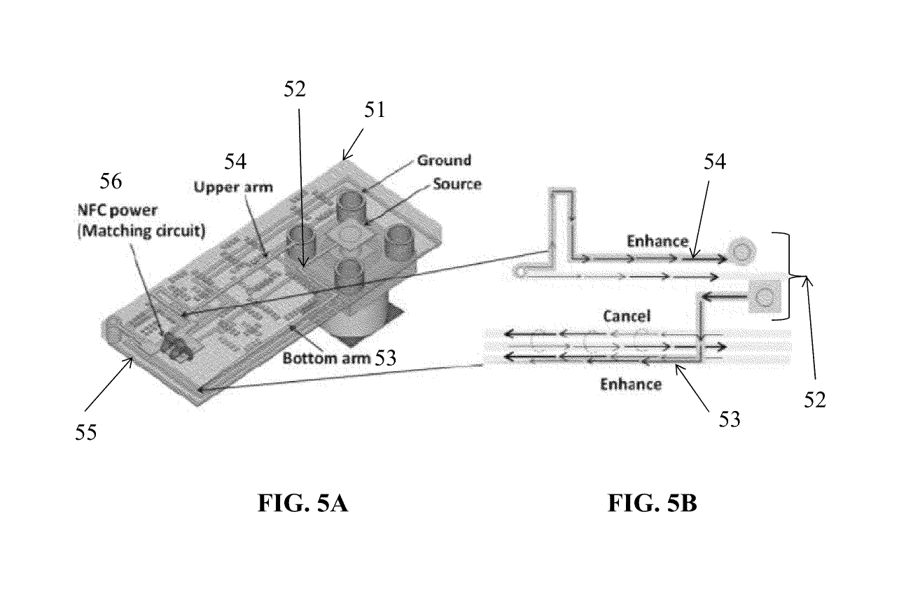

In some embodiments, as illustrated in FIG. 5, an electronic board 51 includes a dual-band antenna 52 which can be used both to power the device and to communicate with the device for data transfer. The dual-band antenna 52 adds minimal or reduced additional space to the electronic board 51 and can be designed to maximize or enhance power and data transfer efficiencies from an external antenna.

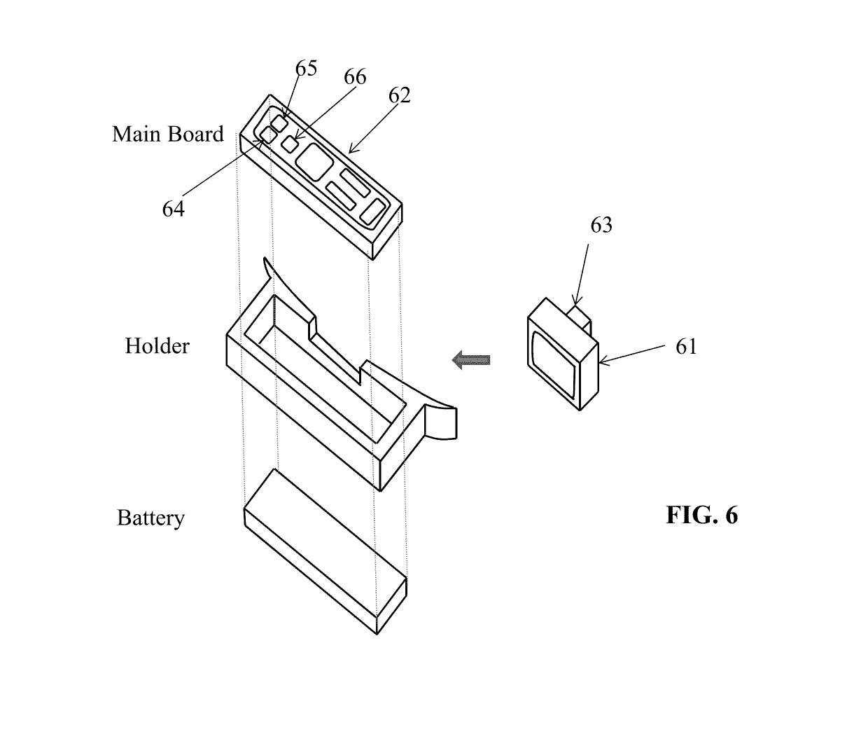

In some embodiments, as illustrated in FIG. 6, the wearable device further includes a daughter electronic board 61 which can be mounted near a main electronic board 62 to incorporate additional circuitry. The daughter electronic board 61 can include additional power or data communication antenna, or other circuits, such as proximity sensing using an infrared proximity sensor 63 to detect misplacement of the device. The size of the daughter electronic board 61 can be minimized or reduced to control the size of the overall electronic package. The orientation of the daughter electronic board 61 can be optimized to prevent any discomfort when a human subject wears the device, such as in a substantially orthogonal orientation to the main electronic board 62.

In some embodiments, the main electronic board 62 and the daughter electronic board 61 further include temperature sensing circuitry 64, vital sign monitoring circuitry 65, alarm 66, or other signal indicators. In some embodiments, the alarm 66 or other signal indicators can signal severe impact or other abnormal body conditions based on preset limits and measurement results.

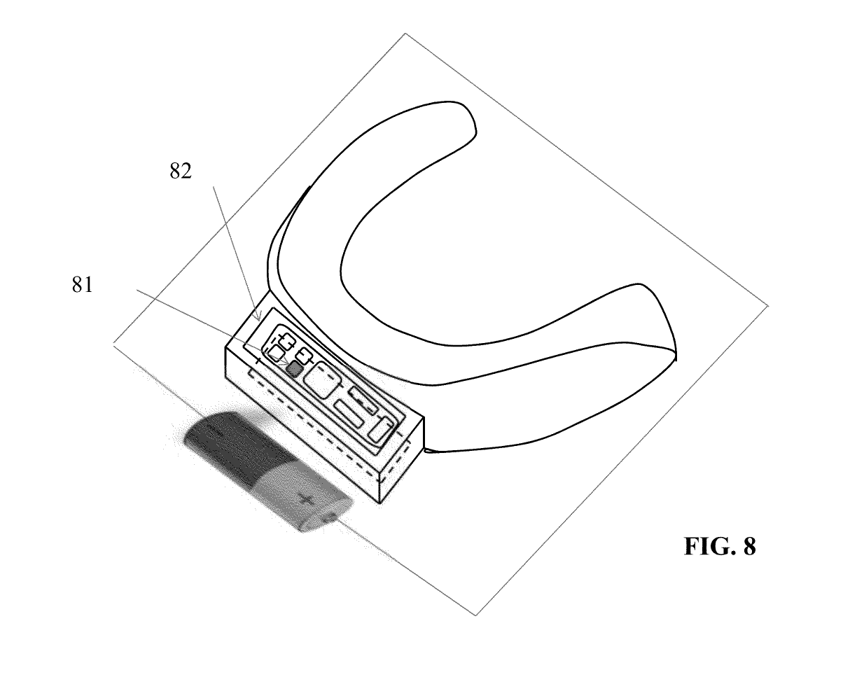

In some embodiments, the main electronic board 82 or the daughter electronic board also includes circuits to provide feedback to the user about the device charging status, such as an LED indicator 81 indicating charging or full battery as shown in FIG. 8. In some embodiments, the device further includes circuits for communicating with an external charging station about the charging status such that the external charging station can go to a sleep mode or a receive-only mode once the impact measurement device is fully charged.

iii. Dual-Band Antenna

In some embodiments, data collected by the wearable device can be downloaded after suitable processing. In some embodiments, the main electronic board or the daughter electronic board includes an antenna for far field communication, such as Bluetooth, ZigBee, Wi-Fi, WiMAX and UWB, for either real-time or offline data communication with the wearable device.

In some embodiments of the wearable device, a rechargeable battery is affixed to or embedded in the base member to provide electric power to the circuits in the wearable device, and a near field antenna is formed (e.g., printed) on the electronic board to charge the rechargeable battery wirelessly. In some embodiments, the antenna for wirelessly charging the rechargeable battery is an antenna for NFC or an inductive power transfer standard, such as Qi.

In some embodiments, wireless power and data communication with a wearable device avoids the use of exposed contact leads for charging the battery and allow the hermetically sealing of the electronic circuitry against fluid ingression and performance degradation.

In some embodiments, Bluetooth is used as a wireless standard for transferring data over short distance. Bluetooth is standardized in IEEE 802.15.1 and operates at about 2.4 GHz band. The latest version of Bluetooth standard, Bluetooth v4.0, includes a low-energy mode that is well suited for wearable device powered by a battery.

In some embodiments, Qi is used as an interface standard for inductive power transfer. The operating frequencies of Qi are from about 110 to about 205 KHz for low power inductive charging at up to about 5 W, and from about 80 to about 300 KHz for medium-power charging. Due to the low operating frequency and therefore the long wavelength of Qi, a Qi antenna on a receiver may have a large number of turns in order to efficiently couple with an antenna on a transmitter. In some embodiments, NFC, operating at about 13.56 MHz for contactless data transfer over distances less than about 10 cm can also be used for power transfer.

In some embodiments, utilizing the same area for multiple wireless interfaces and multiple functions is both economically and technically advantageous. Most wireless devices employ separate antennas for data and power communications, which are built upon two very different wireless interfaces. As modern wireless devices are shrinking in size while the components and features in a device are growing in number, printed circuit board (PCB) real estate becomes precious. Fitting separate antennas for power and data communication onto a wearable device with limited board area could reduce the available space for individual antennas. Furthermore, when the two antennas are not far apart, their metallic structures load each other, creating excessive coupling and interference between the antennas, which reduces the performance of the antennas and renders the design difficult.

In some embodiments of the present disclosure, a single dual-band antenna that meanders around the electronics on the electronic board is used for wireless power and data communication. A single dual-band antenna, such as an asymmetric dipole antenna, can minimize or reduce the electromagnetic interference between the near field and the far field radiation fields, and maintain impedance matching by connecting a single-turn or multi-turn inductive loop to one arm of the dipole antenna.

FIG. 5 illustrates an embodiment of a dual-band antenna 52 using an asymmetrical dipole, where the length of each dipole arm 53 or 54 is about one-quarter wavelength of an operating frequency, such as about 2.4 GHz. In some embodiments, the dipole arms 53 and 54 may have lengths other than one-quarter wavelength of the operating frequency. The two dipole arms 53 and 54 reside on the front side of the electronic board 51, functioning for the Bluetooth frequency band. The bottom arm 53 is tapered for bandwidth enhancement. The upper arm 54 of the dipole is connected to a multi-turn loop 55 on the back side of the electronic board 51 with a matching circuit 56 placed on the front side. The multi-turn loop 55 functions for the NFC frequency band. The matching circuit 56 tunes the self-inductances of both the Bluetooth and the NFC antenna elements. The multi-turn loop 55 on the back side of the electronic board 51 is at least partially or substantially fully circumferential, extending at least partially (e.g., at least about 50%, at least about 60%, at least about 70%, or more) or substantially fully around a periphery of the electronic board 51, or at least partially or substantially fully around one or more electronic devices mounted on the electronic board 51. The number of turns in the multi-turn loop 55 can be 2 or more, 3 or more, 4 or more, 5 or more, 6 or more, or 7 or more.

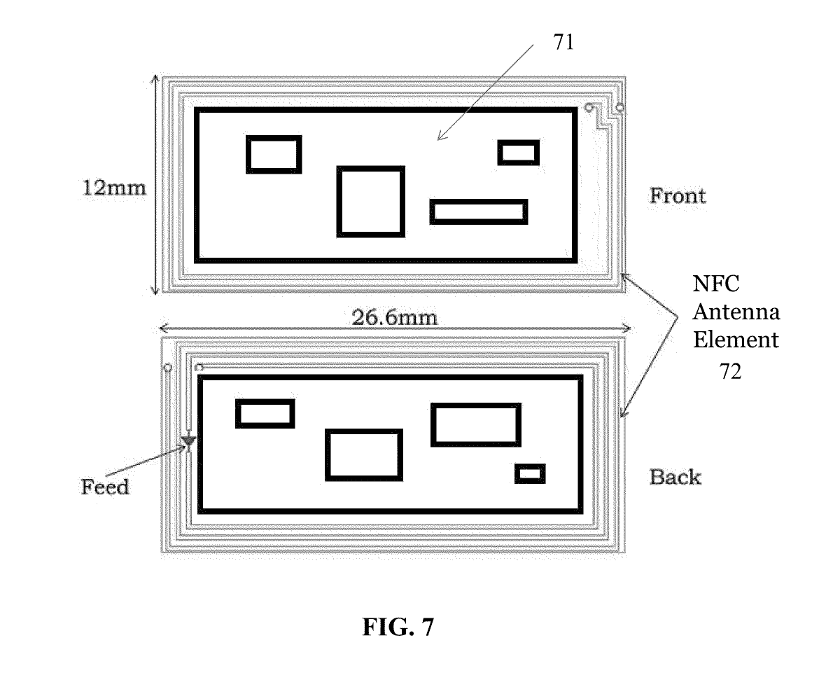

FIG. 7 illustrates another embodiment of an electronic board 71 which includes a circumferential NFC antenna element 72. The circumferential NFC antenna element 72 extends at least partially or substantially fully around a periphery of the electronic board 71, or at least partially or substantially fully around one or more electronic devices mounted on the electronic board 71.

iv. Hermetic Sealing

In some embodiments, high-quality hermetic sealing is used to protect electronic circuits in the wearable device. The degree and measure of hermeticity are a function of material choice, final seal design, fabrication processes and practices, and the application environment. Materials and jointed assemblies may leak to some degree, whether by permeation through the bulk material or along a discontinuity path. A parameter characterizing the amount of leakage that can pass through a solid material is permeability, which is a combination of mass, distance, time, and pressure.

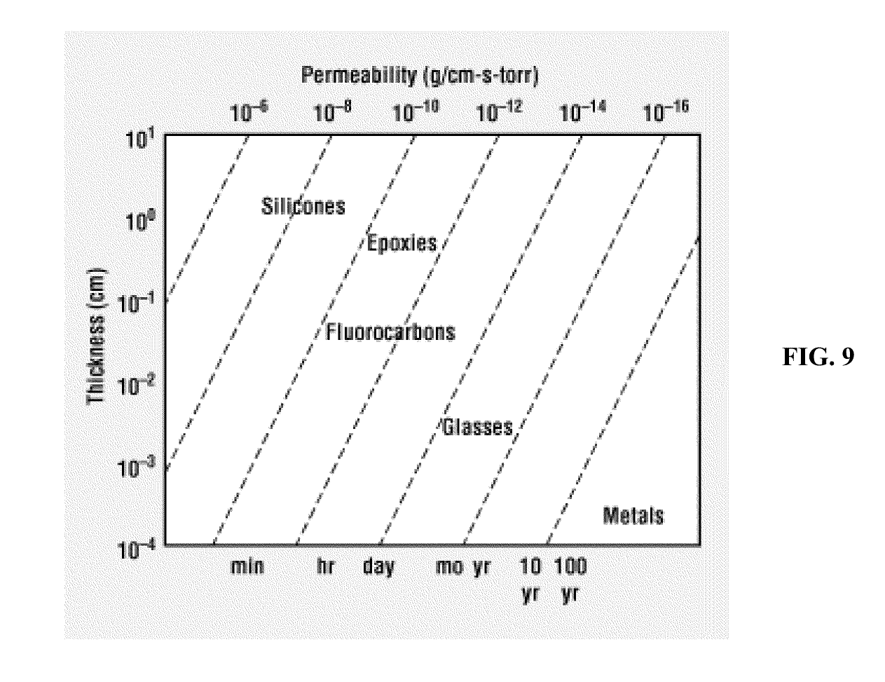

In some embodiments, many organic polymeric materials can be used as encapsulates for hermetic sealing. These materials include epoxies, silicones, polyurethanes, polyimides, silicone-polyimides, parylenes, polycyclicolefins, silicon-carbons, benzocyclobutenes, and liquid crystal polymers. FIG. 9 illustrates typical permeability values of many classes of materials.

In some embodiments, the process of ensuring hermeticity includes the selection of material and manufacturing techniques that yield an enclosure that has sufficient material thickness to impede the diffusion of gas into an internal package cavity and can be sealed without pinholes, cracks, or other discontinuities that provide a direct leak path. The total leakage of a hermetic sealing is a combination of both the bulk permeation through the material and any open leak paths that lead directly from the internal to the external environment. Welds and joints between materials may have preexisting cracks or pores that provide a leakage path.

In some embodiments, hermeticity is measured by a dye-penetrant, a bubble-emission, a pressure-decay, a microbial-ingress, a radioactive, or a mass spectrometer system. MIL-STD-883, Method 1014.10 provides the details of various hermeticity test procedures that have been adapted by the biomedical device industry. Regardless of the measurement system, the basic approach for hermeticity measurement is similar. A pressure difference is developed between the internal volume of the package and the external environment. This pressure gradient causes gas or liquid to diffuse or leak through the bulk material or the sealed area. The material leaking through the hermetic sealing to the external environment is then sensed. In the case of radioactive, microbial, and mass spectrometer methods, the test can be both qualitative and quantitative.

In some embodiments, the hermeticity measurement method used is a helium-leak detector. A helium leak rate is measured at about one atmosphere pressure differential and about 20° C., and is defined as helium atoms per cubic centimeter per second (atm/cm³/sec). A helium-leak detector is a mass spectrometer tuned to analyze the helium gas. The detection limit of a helium-leak tester is generally about 1×10⁻⁹ atm/cm³/sec or better. Prior to the helium-leak test, the hermetic package can either be subjected to high-pressure pure helium for a period of time (“bombed”) or sealed in a helium-containing environment. Calibration of the helium-leak detector can be accomplished using a calibrated helium-leak standard involving a small cylinder charged with helium at atmospheric pressure. The cylinder contains a filter through which helium exits at a fixed calibrated rate when the cylinder valve is opened, and the temperature at which the leak is calibrated is marked on the cylinder (typically 22 to 23° C.).

In some embodiments, the wearable device for impact measurement has a leak rate of about 10⁻⁴ atm/cm³/sec or lower, such as about 10⁻⁵ atm/cm³/sec or lower, about 10⁻⁶ atm/cm³/sec or lower, about 10⁻⁷ atm/cm³/sec or lower, or about 10⁻⁸ atm/cm³/sec or lower.

b. External Charging Station

The present disclosure also provides, in some embodiments, an external charging station for charging and communicating with a wearable device, wherein the external charging station includes a power source and an external antenna configured to transmit wireless signals towards the wearable device. In some embodiments, the external charging station can be embedded in places such as smartphones, body garments, helmets, and sports fields. In some embodiments, the external antenna can be powered by battery, alternative current (AC) electricity, or other energy sources. In some embodiments, the wearable device can be charged during use by external charging stations on a sports field. It can also be charged before or after being used on the field.

i. External Antenna

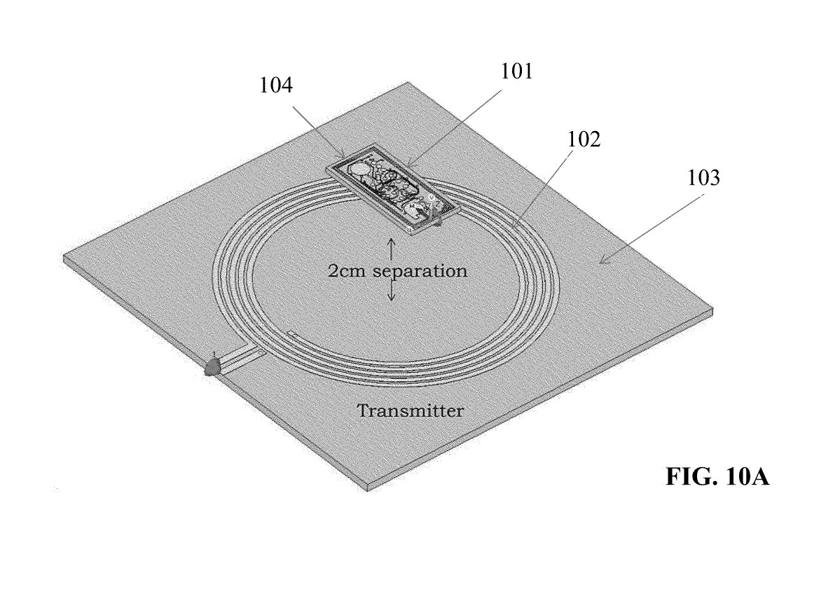

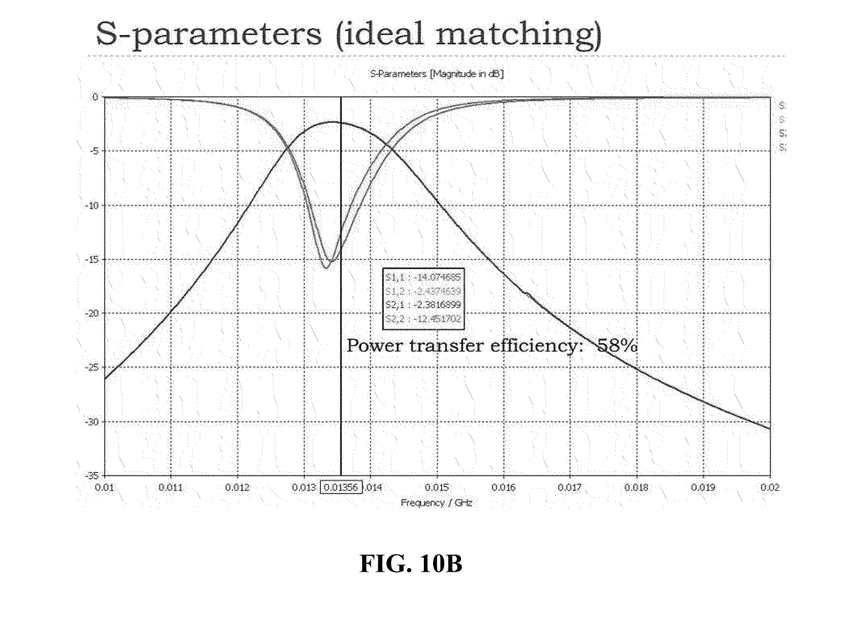

FIG. 10A depicts a configuration of a wearable device 101 charged with an external antenna 102 on a charging station 103. FIG. 10B illustrates the power transfer characteristics of such configuration, where an antenna 104 on the wearable device 101 and the external antenna 102 on the charging station 103 are matched, and the S-parameter S₂₁ or S₁₂ between the antenna 104 and the external antenna 102 is about −2.4 dB at about 13.56 MHz, which corresponds to a power transfer efficiency of about 58% between the wearable device and the charging station. In some embodiments, the S-parameter S₂₁ or S₁₂ between the antenna 104 and the external antenna 102 is about −1 dB to about −6 dB. In some embodiments, the power transfer efficiency between the wearable device 101 and the charging station 103 is at least about 25%, at least about 40%, at least about 50%, at least about 60%, at least about 70%, at least about 80%, or more.

In some embodiments, the external antenna on the charging station can also be a dual-band antenna for both power and data communications.

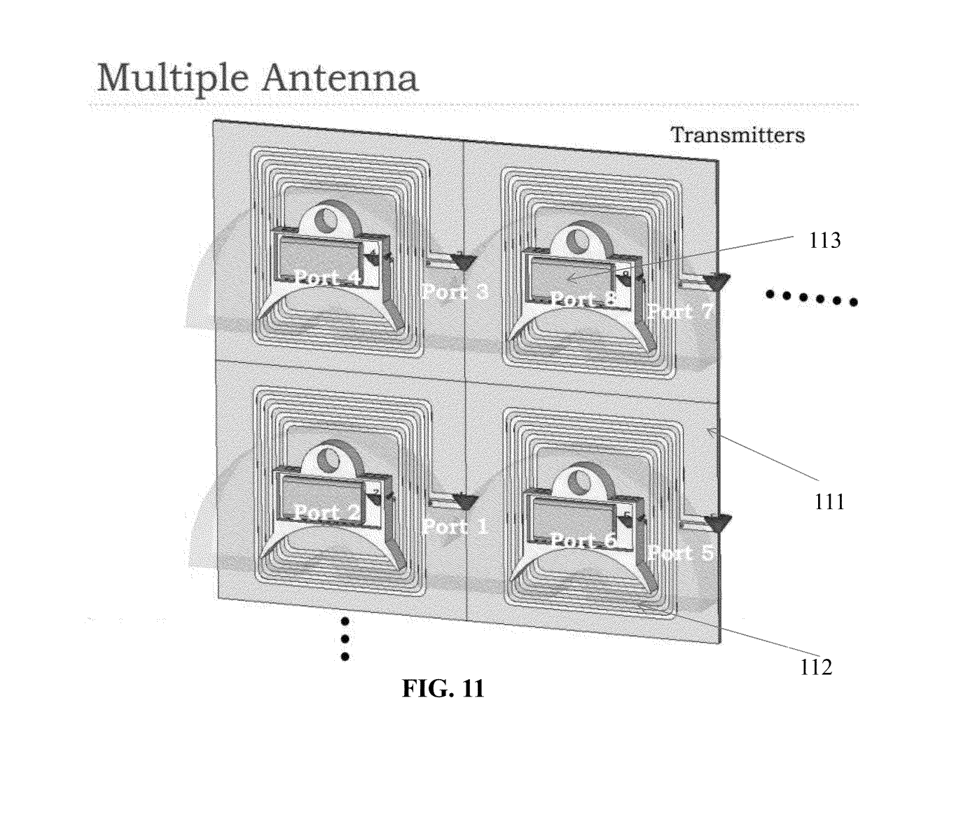

In some embodiments, as shown in FIG. 11, an external antenna 112 on a charging station 111 is a one-dimensional or two-dimensional array for efficient charging and communicating with multiple wearable devices 113 at the same time. In some embodiments, multiple external antennas 112 can charge one wearable device 113 at the same time for faster charging.

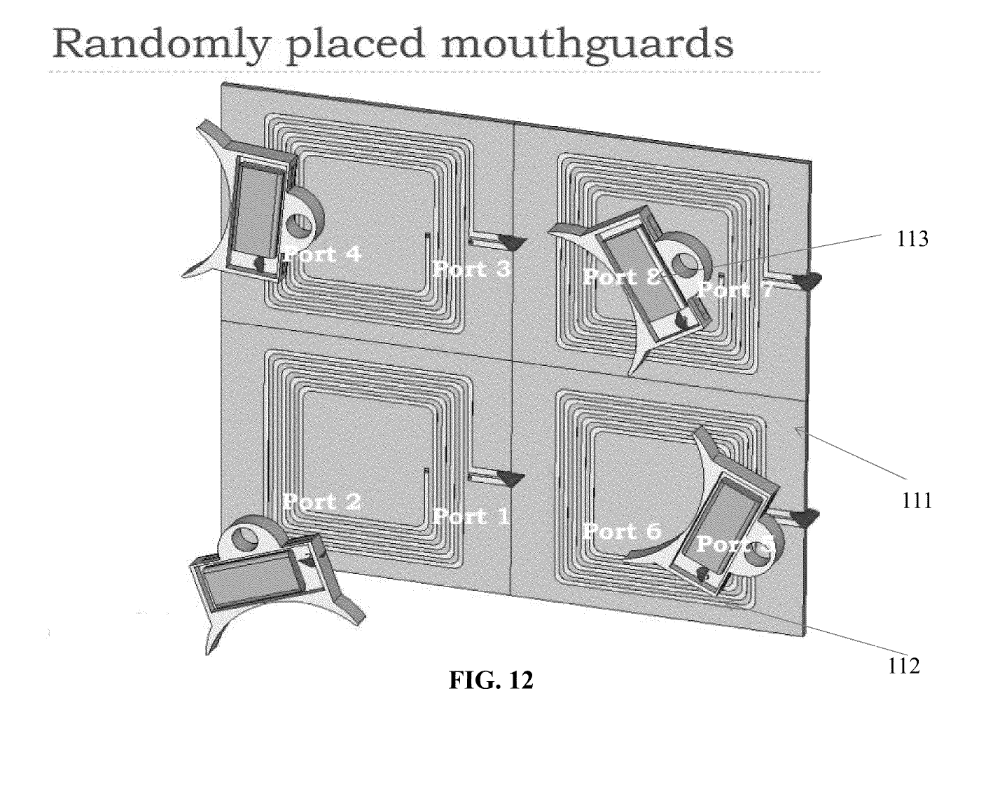

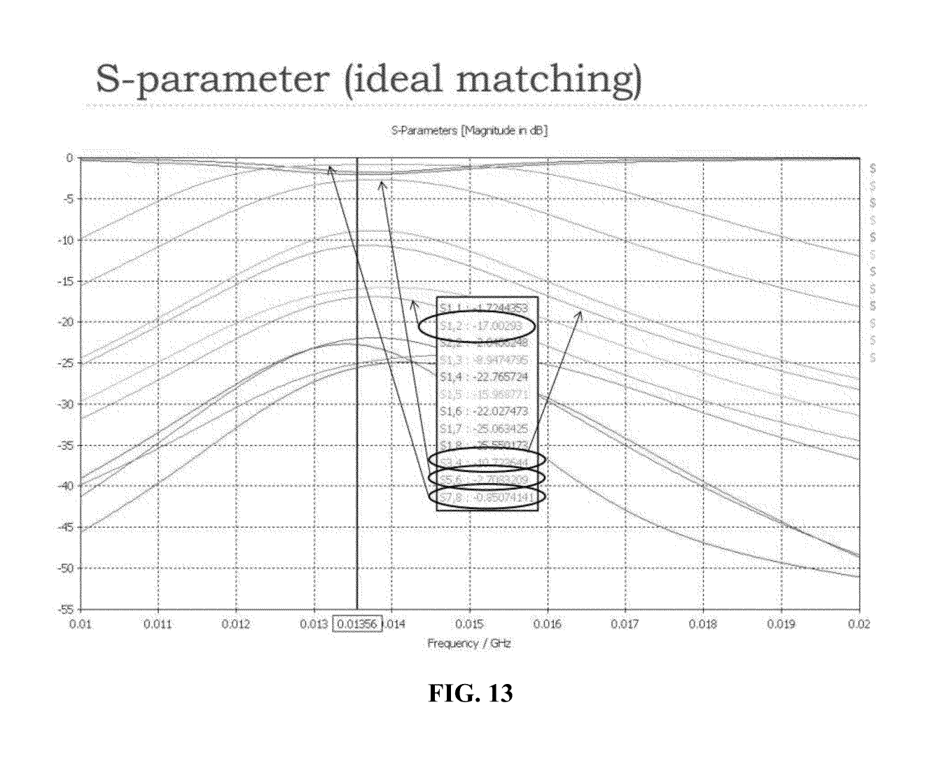

In some embodiments, the wearable device can be placed in different orientations and different locations with respect to the external antenna for efficient charging and communication. FIG. 12 and FIG. 13 illustrate the power transfer characteristics of some configurations with different wearable device placements, which show that the power transfer characteristics is substantially unaffected by the location and orientation of the wearable device with respect to the external antenna.

In some embodiments, a near field communication antenna in a smartphone can be used to charge and download data from the wearable device, where the wearable device can be laid down near a smartphone on a table, and the smartphone can include a software application to charge and download data from the wearable device. In some embodiments, as shown in FIG. 14, a smartphone 141 can display battery content and download status during the charging and downloading.

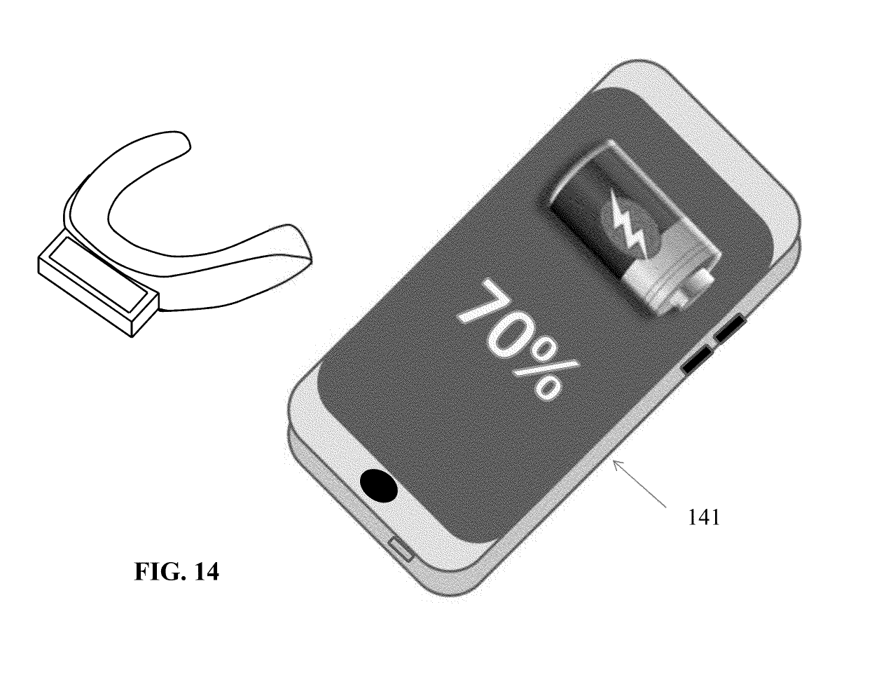

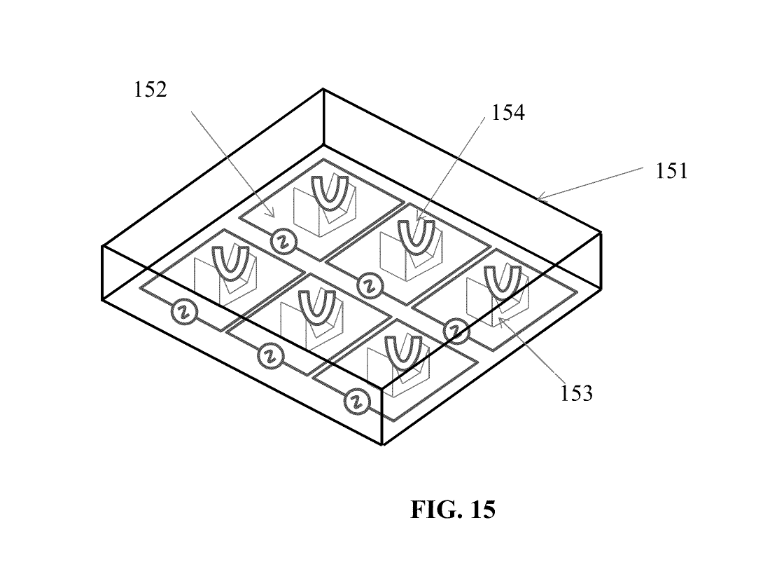

In some embodiments, as shown in FIG. 15, the external charging station can be a charging box 151 with antennas 152 and device slots 153 shaped to fit the wearable devices 154 to charge the wearable devices placed inside the charging box 151, where the antennas 152 and device slots 153 are optimized for maximum power transfer efficiency.

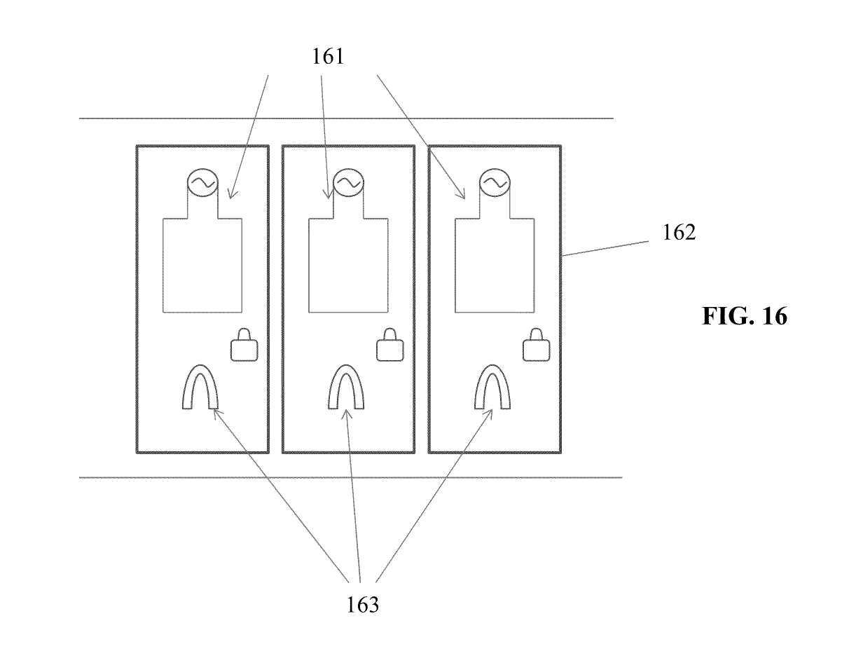

In some embodiments, as shown in FIG. 16, an antenna 161 can be embedded into a player's locker 162 for charging or downloading from a wearable device 163 placed in or near the locker 162.

In some embodiments, the external antenna can be set to a sleep mode or a receive-only mode so that the external antenna could stop transmitting wireless power to save energy once it receives signals indicating that the impact measurement device is fully charged.

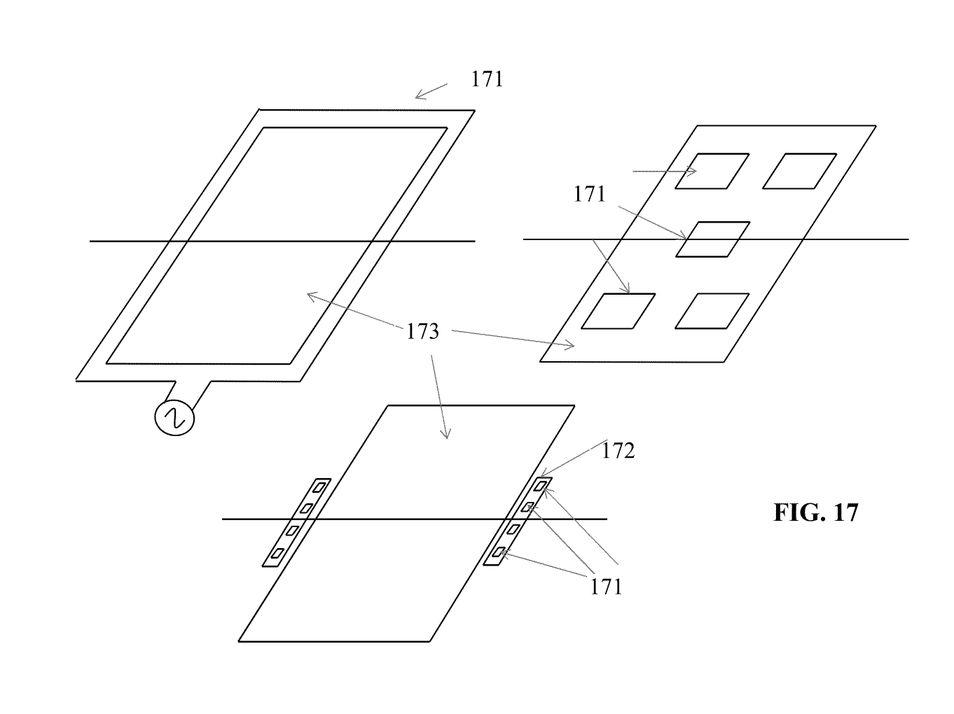

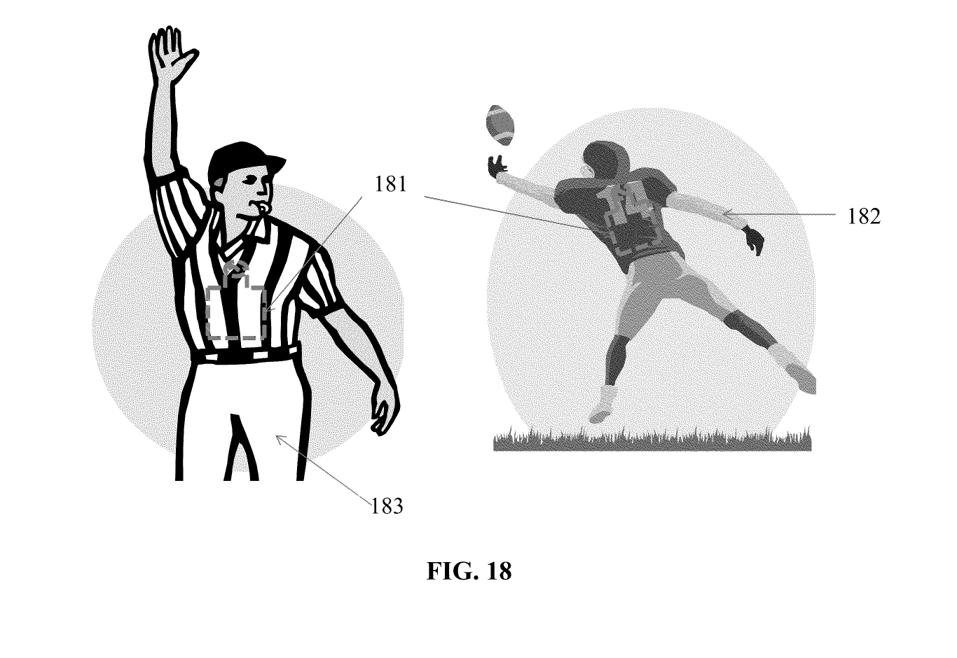

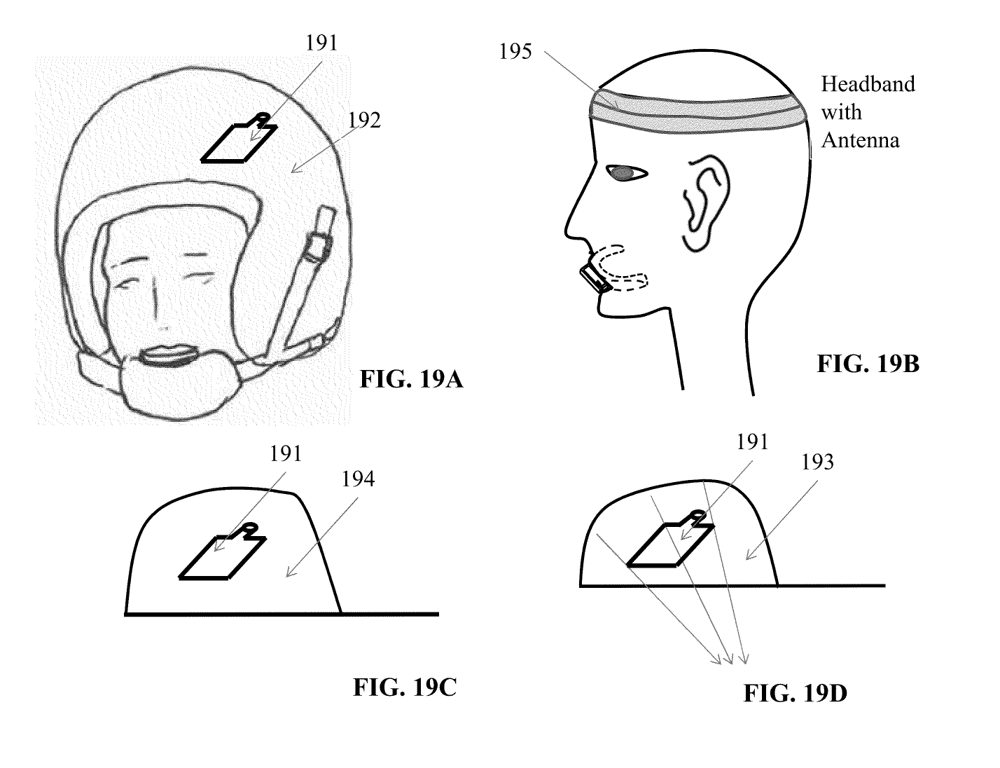

In some embodiments, the impact measurement device can be charged by external antennas during usage. In some embodiments, as shown in FIG. 17, one or more external antennas 171 can be embedded on mats 172 or underground at various areas on a sports field 173, wherein the antennas can be continuously powered and can charge devices continuously on the field. In some embodiments, as shown in FIG. 18, external antenna and charging units 181, such as battery packs, can be embedded on the players 182 or other personnel on the field, such as a referee 183, for continuous charging of nearby devices. In some embodiments, external antennas 191 can be embedded into body garments or equipment such as helmets 192, hats 193, caps 194, and headbands 195 as shown in FIGS. 19A-19D. In some embodiments, such as the one shown in FIG. 19D, the external antenna 191 and the hat 193 can be configured such that the emitting power from the external antenna 191 is focused for more efficient and faster charging.

ii. Power Source

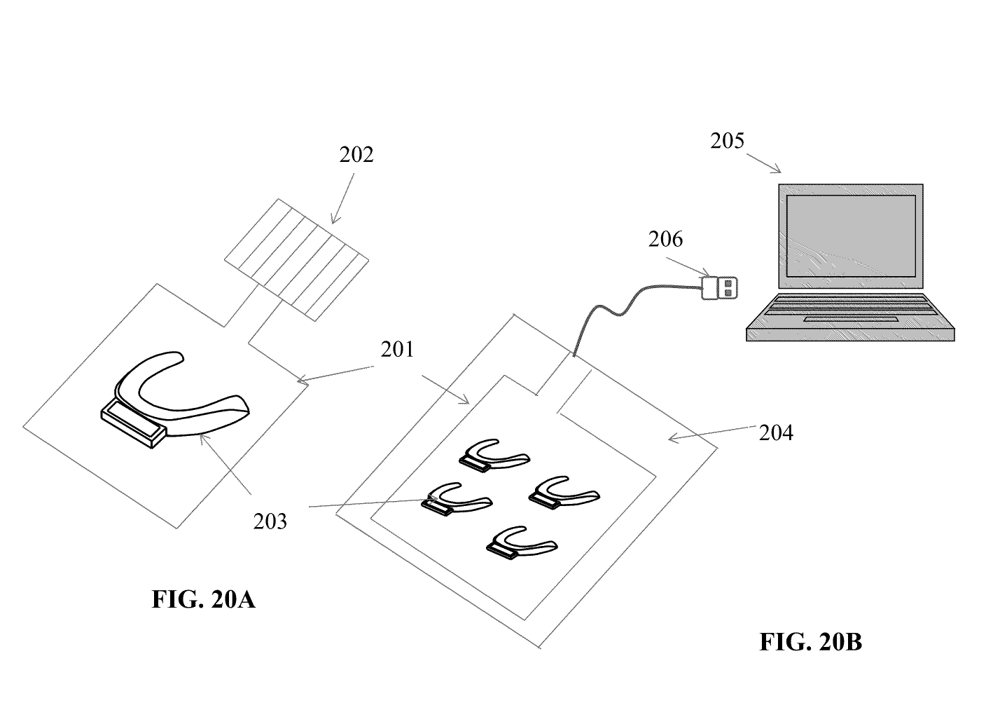

In some embodiments, the external charging station can be powered by a battery or AC electricity from a wall outlet. In some embodiments, as shown in FIG. 20A, the external antenna 201 can be powered by solar panels 202 to charge nearby devices 203. In some embodiments, as shown in FIG. 20B, the external charging station 204 can be configured as a plate or a box that can be plugged into any computer 205 or other devices via a USB cable 206 to charge nearby devices 203.

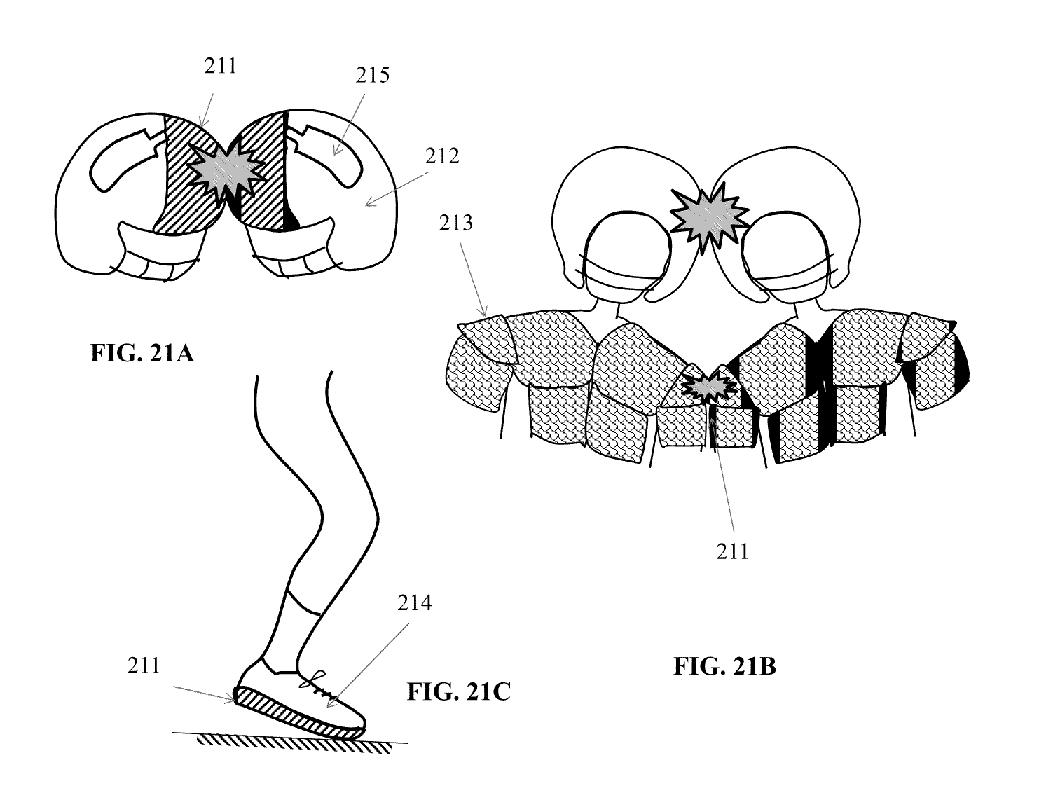

Other energy sources can also be harvested to power the external antennas to wirelessly charge the wearable devices. In some embodiments, the external antenna can be powered by energy from on-field movements. In some embodiments, as shown in FIGS. 21A-21C, piezoelectric power generating elements 211 can be embedded into helmets 212, paddings 213, or on the bottom of shoes 214, such that during collision or anytime when a pressure is exerted on the piezoelectric power generating elements 211, these elements will generate power to power an antenna 215 for charging the wearable device.

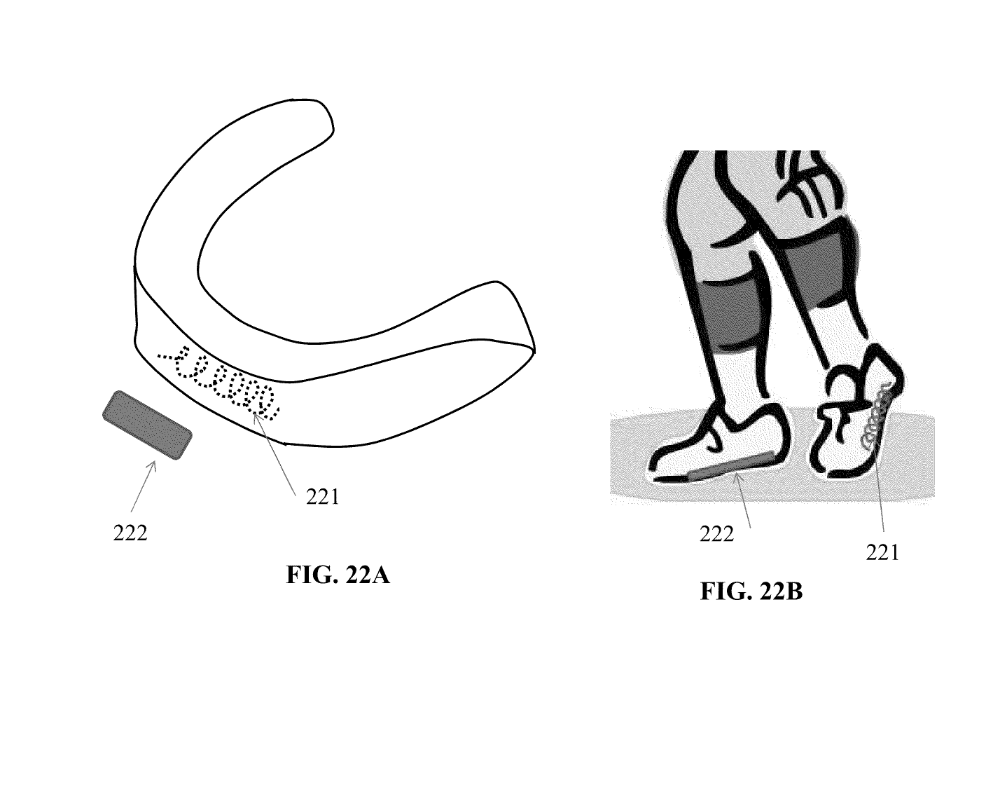

In some embodiments, as shown in FIGS. 22A-22B, a coil-magnet pair can be used for electromagnetic power generation through relative movements of the coil 221 through a magnetic field generated by the magnet 222, wherein the relative movements can be achieved via player motion.

In some embodiments, pyroelectric, thermoelectric, electrostatic, or biomechanical generator can be used to power the external antennas. In some embodiments, electroactive polymers (EAP) can be used to harvest energy to power the external antennas, where the total weight of the system could be significantly lower. In other embodiments, noise on the sports field can also be harvested to power the external antennas.

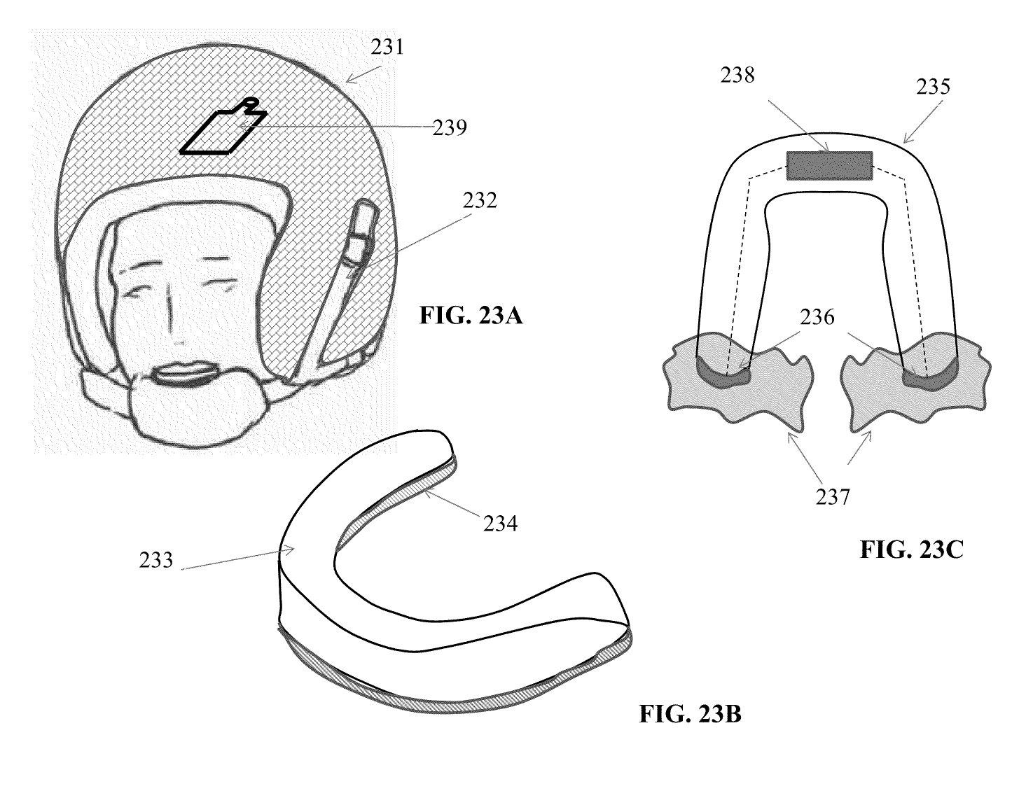

In some embodiments, as shown in FIG. 23A, the external antenna 239 on the charging station can be powered by photovoltaic cells 231 affixed on the helmets 232 or garments to receive solar power for charging the wearable devices.

In some embodiments, as shown in FIG. 23B, a wearable device 233 having a shape of a mouthguard can include piezoelectric power generating elements 234 to generate power from the pressure of biting motion to power the wearable device 233.

In some embodiments, as shown in FIG. 23C, a wearable device 235 can include electrodes 236 such that when the electrodes are submerged in saliva 237, a conductive fluid, a chemical battery is formed to power the circuitry 238 of the wearable device 235.

### EXAMPLE

The present disclosure will be understood more readily by referring to the following example, which is provided by way of illustration and is not intended to be limiting. In the example, different dual-band antennas at the NFC and the Bluetooth bands for wireless power and data communication on a wearable impact measurement device in the form of a mouthguard are designed and evaluated. The structures and designs of the dual-band antennas can be used in wearable devices for other applications as well.

### Antenna Design

A Bluetooth antenna operates in the far-field region of a source at about 2.4 GHz with a half wavelength of about 6.25 cm, which is too large for an electronic board used in a wearable impact measurement device such as a mouthguard. A straight antenna can be bent to meander around circuits on the electronic board to reduce the overall dimensions while retaining the same conductor length. However, a meandered antenna has a decreased self-capacitance, which results in a higher resonant frequency. To resonate at the original frequency, the length of the antenna may need to be increased, which compromises the initial goal of meandering.

NFC antenna operates in the near-field region of a source. In NFC, the coupling between a transmitter and a receiver can be realized through the time-varying magnetic field using multi-turn coils. NFC antennas are designed to be as large as possible to maximize or enhance the electromagnetic coupling. The transmitter and receiver in a NFC system is equivalent to a source oscillator driving a load through an ideal transformer. The parasitic inductance of a coil may involve some capacitance to tune it out to form a bandpass or band-stop LC circuits. The tuning can be achieved by a network of lump components, such as capacitors and inductors.

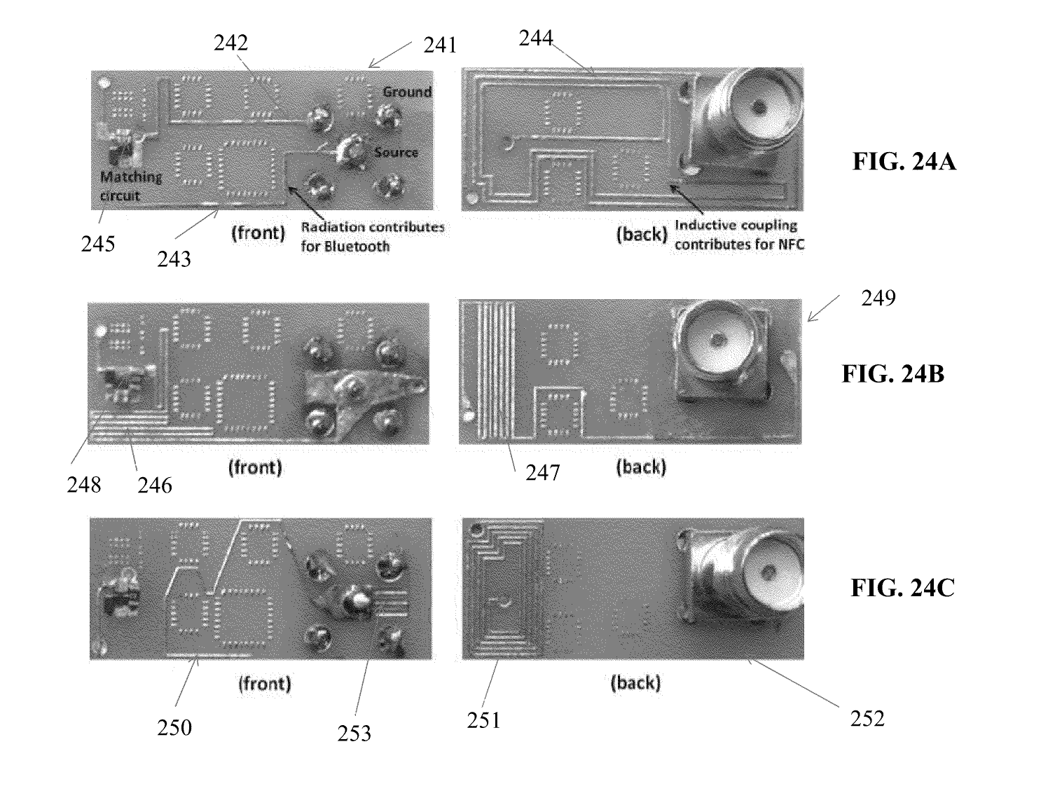

In the example, an asymmetric dipole structure is used for a dual-band antenna. The length of each dipole arm is about one-quarter wavelength at about 2.4 GHz. The two arms 53 and 54 of the dipole reside on the front side of the electronic board 51, as shown in FIG. 5A. The bottom arm 53 of the dipole is tapered for bandwidth enhancement. The upper arm 54 of the dipole is connected to a 3-turn loop 55 on the back side of the electronic board 51 with a matching circuit 56, such as a 720 pF capacitor, placed on the front side. The matching circuit 56 tunes the self-inductances of both the Bluetooth and the NFC antenna elements. To enhance the current flow, the upper arm 54 on the front side is located in the vicinity of the 3-turn loop 55 on the back side as shown in FIG. 5A. The current flow switches at the end of the dipole arms 53 and 54, shifts its phase by 180 degrees, and is transmitted to the 3-turn loop 55 on the back side of the electronic board 51. The 3-turn loop 55 on the back side of the electronic board 51 extends in the opposite direction of the upper arm 54 such that both currents are in-phase, and therefore produces more efficient radiation. On the other hand, the bottom arm 53 and the 3-turn loop elements 55 are located close to one another such that a pair of loop elements can cancel the current of each other. Therefore, the coupling between the Bluetooth and the NFC antenna elements can be minimized or reduced, and the current flow on the bottom arm can be enhanced. A fabricated asymmetric dipole antenna on an electronic board 241 with an upper arm 242, a bottom arm 243, a 3-turn loop 244, and a matching circuit 245 is depicted in FIG. 24A.

Two different structures of an antenna for wireless power and data communication, Alternative 1 antenna (shown in FIG. 24B) and Alternative 2 antenna (shown in FIG. 24C), are also designed and evaluated. Because a larger number of turns in a loop increase the electromagnetic coupling between the Bluetooth antenna and the NFC antenna, the number of turns in the loop can be reduced to reduce the coupling between the two antennas. The Alternative 1 antenna includes two monopole elements 246 and 247, the ends of which are connected through a matching capacitor 248 to tune out the self-inductance and form a 1-turn loop. The monopole elements 246 and 247 can also be meandered at their ends to increase the inductance for impedance matching for the Bluetooth antenna element and increase the effective power transfer of the NFC antenna element. Since there is no other antenna element on the back side of the electronic board 249 to cause the electromagnetic coupling, the radiation efficiency of the Alternative 1 antenna is higher than the asymmetric dipole antenna. However, the NFC power transfer efficiency of the Alternative 1 antenna is lower due to its smaller number of turns.

In Alternative 2 antenna, the electromagnetic interference between the Bluetooth and the NFC antenna elements 250 and 251 is mitigated by using different areas for the Bluetooth and the NFC antenna elements 250 and 251 to minimize or reduce the coupling between them. The Bluetooth antenna element 250 is placed on the front side of the electronic board 252, while the NFC antenna element 251 is placed on the back side of the electronic board 252. The Bluetooth and the NFC antenna elements 250 and 251 can be independently optimized. To maximize or enhance the radiation efficiency of the Bluetooth antenna element 250, a capacitor 253 is added to match the inductive input impedance of the Bluetooth antenna element 250. The NFC antenna element 251 includes a 4-turn loop. However, it does not maximize the power transfer efficiency of the NFC antenna element 251 because of the limited space available for the NFC antenna element 251 in order to separate it from the Bluetooth antenna element 250. But the Alternative 2 antenna can achieve higher power transfer efficiency than the Alternative 1 antenna because of its larger number of turns. The Alternative 2 antenna occupies more real estate to achieve the same performance for both the Bluetooth and the NFC applications as the asymmetric dipole antenna.

### Numerical Analysis

The antenna characteristics of the designed antennas are simulated using a full-wave electromagnetic field simulation software, which adopts a Finite Integration technique. The asymmetric dipole antenna is optimized by changing the length of the meandered line of the upper arm and the path of the bottom arm of the dipole based on the simulation results.

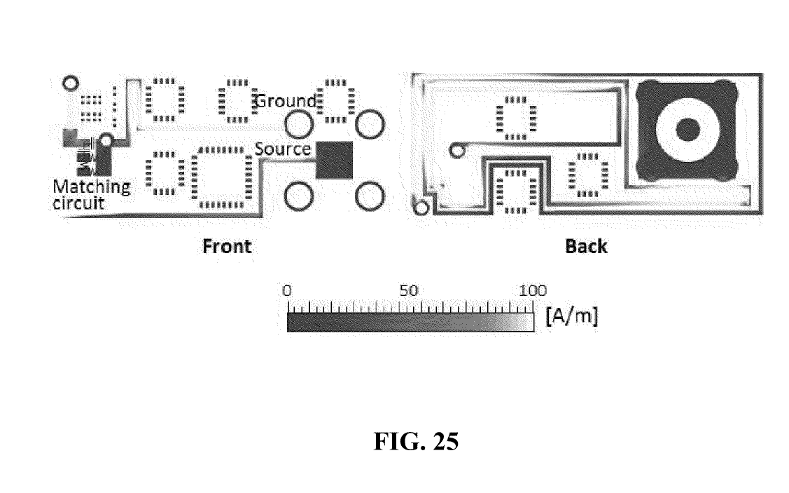

FIG. 25 illustrates the simulated surface current distributions on the asymmetric dipole antenna at about 2.45 GHz. The strongest current path is along the asymmetric dipole on the front side, and in the loop on the back side of the electronic board. However, the currents in the loop on the back side of the electronic board cancel out because they run in opposite directions at about 2.45 GHz as the dielectric-loaded half quarter-wavelength at this frequency is about 15 mm, close to the physical dimension of the loop. The canceled currents lead to thermal loss. Thus, the asymmetric dipole antenna has a lower radiation efficiency for the Bluetooth antenna but can provide higher power transfer efficiency for the NFC antenna because the dipole length is negligible compared with the wavelength at the much lower frequency of the NFC band. The current in the upper arm is slightly higher than the current in the bottom arm due to reflections at the ends of the dipole arms.

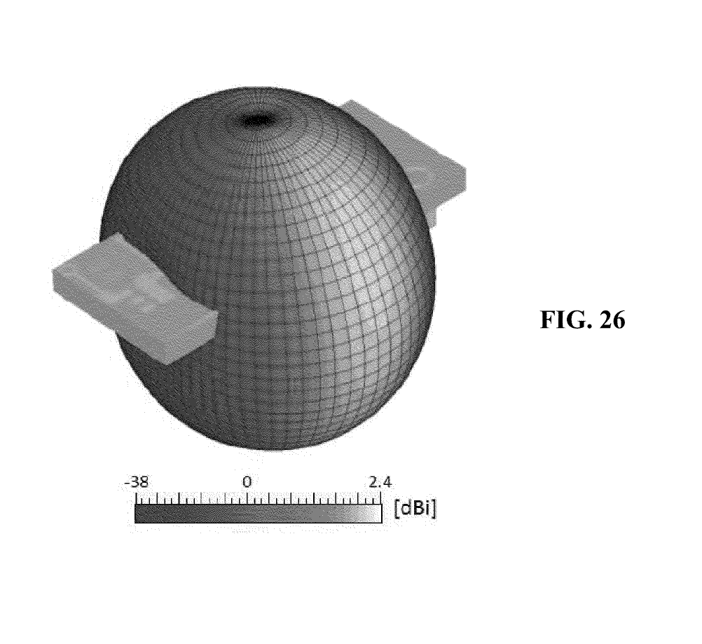

The simulated three dimensional (3D) radiation pattern of the asymmetric dipole antenna at about 2.45 GHz is shown in FIG. 26. The radiation pattern of the antenna is close to a dipole-like pattern. This suggests that the dominant current on the antenna passes along the long side of the PCB board. The current along the short side is minimized at about 2.45 GHz and does not contribute to radiation.

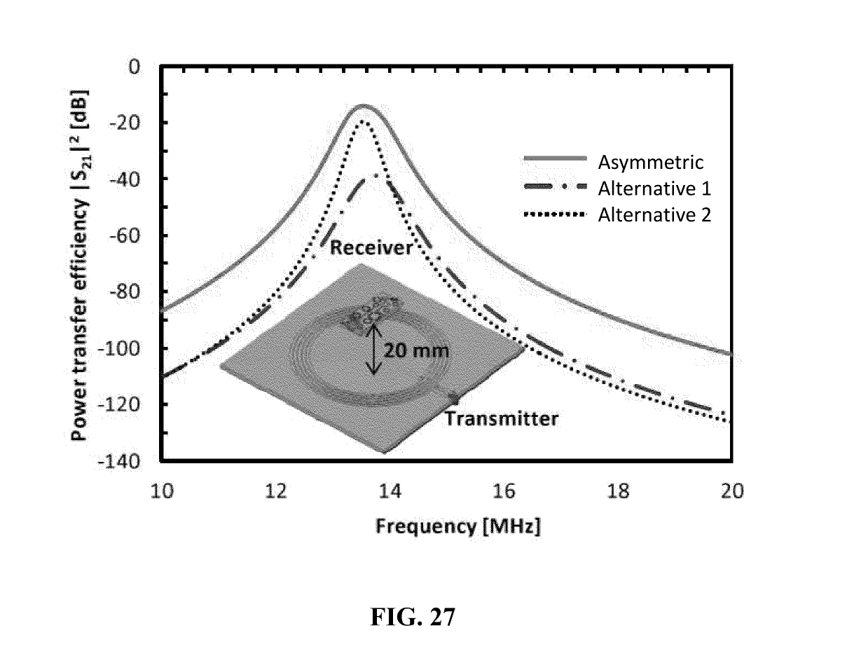

To optimize the wireless power transfer, the matching circuit for the antenna is also simulated. In a system as shown in FIG. 27, a 5-turn coil with an about 50 mm diameter acts as a transmitter and the designed antennas act as receivers when the two antennas are magnetically coupled. For the simulation, the distance between the transmitter and the receiver is set to about 20 mm. FIG. 27 illustrates the simulated power transfer efficiency with matched transmitter and receiver. The transmitter is matched to an about 50 Ohm source, and the matching capacitor is chosen for operation at about 13.56 MHz. In the simulation, the matching capacitor values used are about 720 pF for the asymmetric dipole antenna, about 2.25 nF for Alternative 1 antenna, and about 739 pF for Alternative 2 antenna. The receiver is matched to an about 2000 Ohm rectifier in order to evaluate the receiving power. From the |S₂₁|² between the transmitter and the receiver, power transfer efficiencies are calculated to be about −15 dB (about 18%) for the asymmetric dipole antenna, about −40 dB (about 1%) for Alternative 1 antenna, and about −22 dB (about 8%) for Alternative 2 antenna at about 13.56 MHz. The results demonstrate that power transfer efficiency of the NFC antenna is strongly related to the number of the turns rather than the area of the loop of the antenna.

### Measurement Results

Radiation efficiency is an important parameter of an antenna. The radiation efficiency of small antennas at a certain frequency band can be measured using Wheeler cap method. Voltage and current data of an antenna at high frequencies can be measured through scattering parameters measurement using a vector network analyzer. The Wheeler cap method uses a multimode tuner, designed as an adjustable brass stub with a ring, to compensate for undesirable reduction of the measured efficiency caused by transverse magnetic (TM) and transverse electric (TE) mode resonances of the Wheeler cap. The level of tuning for minimizing the undesirable reduction in the measured efficiency depends on the Q factors of the wheeler cap resonances.

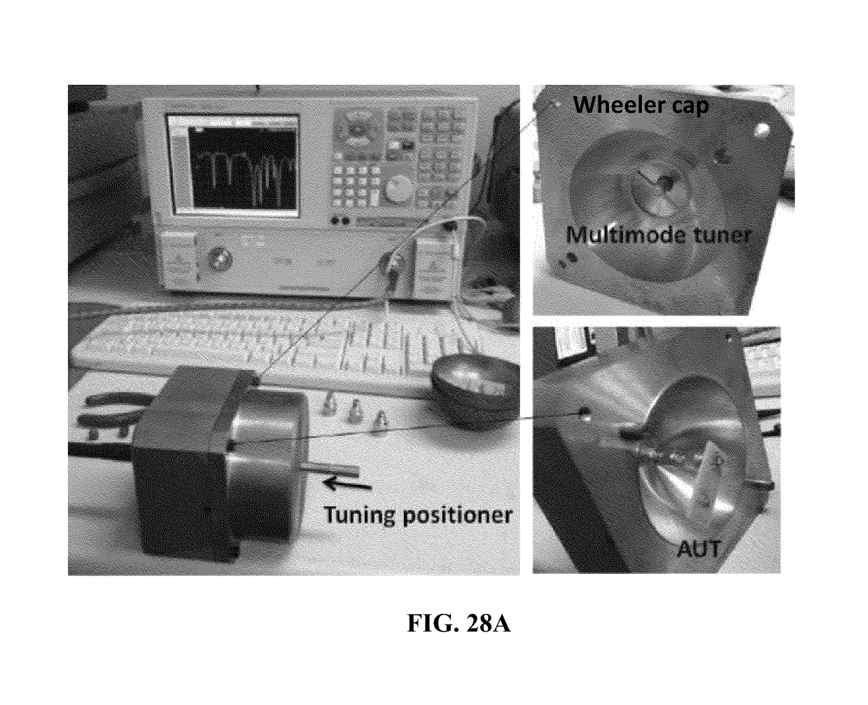

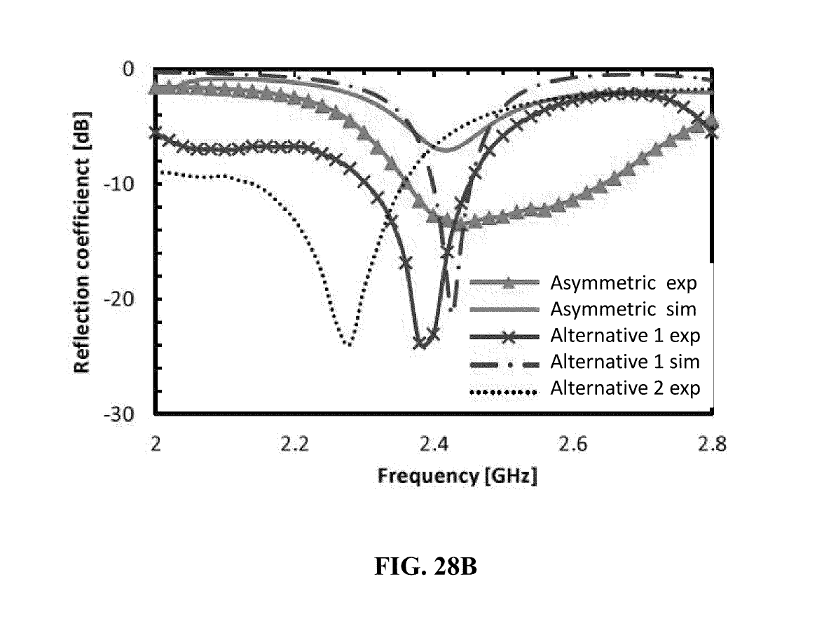

In an experiment setup as shown in FIG. 28A, a tunable spherical Wheeler cap made of brass with an inner diameter of about 70 mm is used. The radiation efficiency of an antenna is determined by measuring the impedance of the antenna installed into a Wheeler cap through a coaxial connection. The radiation efficiency can be calculated using the following equation:

$${η}_{rad} = \frac{{P}_{rad}}{{P}_{in}} = \frac{{\vert {S}_{21} \vert}^{2}}{1 - {\vert {S}_{11} \vert}^{2}} = 1 - \frac{1 - {\vert {S}_{cap} \vert}^{2}}{1 - {\vert {S}_{11} \vert}^{2}} , \qquad ( 1 )$$

where S₁₁ and S_{11cap} are the voltage reflection coefficients of the input port and the Wheeler cap, respectively.

In broadband measurements, the physical size of the Wheeler cap becomes much larger than the wavelength at higher frequencies. Thus, higher-order mode cap resonances can appear in the frequency range, which can cause thermal loss. As a result, the measured efficiency can drop at certain frequencies. To compensate for these losses, a multimode tuner is placed inside the Wheeler cap for tuning the modes. Assuming S₁₁=0, the efficiency drop η_{drop}, can be calculated by

$${η}_{drop} = {\vert {S}_{11 \_cap} \vert}^{2} = \frac{{( {Q}_{L} δ )}^{2}}{1 + {( {Q}_{L} δ )}^{2}} , \\ δ = \frac{Δ f}{{f}_{0}} \qquad ( 2 )$$

where Q_{L} is the Q factor of the Wheeler cap including external loss and cap loss, and δ is the ratio of normalized frequency tuning range Δf to resonant frequency f₀. From Eq. (2), if f₀=10 GHz and Q_{L}=1000, Δf can be no more than 0.07 GHz in order to reduce the efficiency drop η_{drop} to less than 2%. The multimode tuner can be designed to offset both the TM and the TE higher-order mode resonances.

FIG. 28B illustrates the reflection coefficients of the designed antennas measured in free space from 2.0 GHz to 2.8 GHz. The simulation results and the measurement values match well except that the measured values for Alternative 1 antenna are shifted downward by about 50 MHz from the simulation results due to fabrication tolerance.

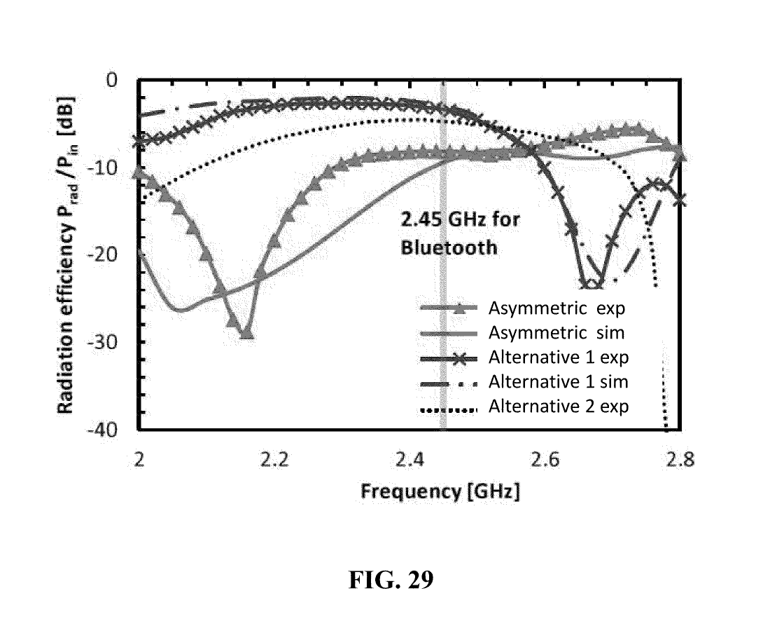

FIG. 29 illustrates the results of radiation efficiency calculated from Eq. (1), which show that the radiation efficiency of an antenna can be a smoothed curve when the higher-order resonant modes are appropriately tuned. The measured radiation efficiencies at about 2.45 GHz are about −8.2 dB (about 39%) for the asymmetric dipole antenna, about −3.2 dB (about 69%) for the Alternative 1 antenna, and about −4.9 dB (about 57%) for the Alternative 2 antenna. The measured radiation efficiencies are slightly lower than the simulation results because of the conductive loss of the current flows on the internal surface of the Wheeler cap. The measured maximum radiation efficiencies between about 2.0 GHz and about 2.8 GHz are about −5.62 dB (about 53%) at about 2.74 GHz for the asymmetric dipole antenna, about −2 dB (about 79%) at about 2.3 GHz for the Alternative 1 antenna, and about −4.58 dB (about 58%) at about 2.45 GHz for the Alternative 2 antenna. These values match the performance of commercial small Bluetooth device products, such as Slim Reach Xtend™ Bluetooth and IEEE 802.11 b/g/n wireless local area network (WLAN) Chip Antennas from Fractus Co., Ltd., which have radiation efficiencies ranging from 50% to 70%. In some embodiments, a radiation efficiency of an antenna can be about 30% or more, about 40% or more, about 50% or more, about 60% or more, about 70% or more, or about 80% or more.

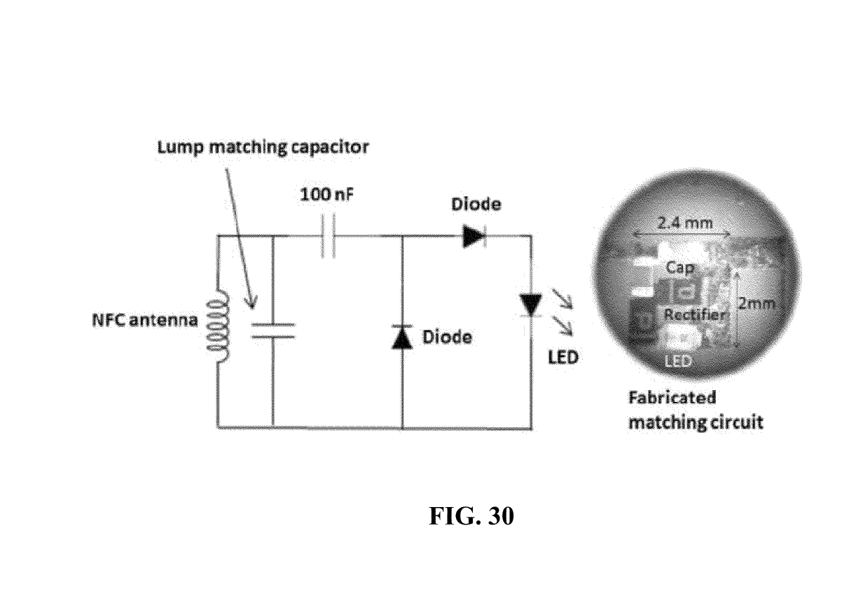

A Light-Emitting Diode (LED) is used to measure the received power by the NFC antenna. The minimum power required to turn on the LED is about 800 μW. At this power level, the impedance of the rectifier for the LED is about 2000 Ohm. An impedance transformation, as illustrated in FIG. 30, is used to interface with the rectifier because a near-field antenna typically includes a long inductive loop.

The voltage reflected at an interface between two impedances can be determined by

$$Γ = \frac{{Z}_{L} - {Z}_{S}}{{Z}_{L} + {Z}_{S}} , \qquad ( 3 )$$

where Z_{L} is the load impedance, and Z_{S} is the source impedance. With a NFC antenna inductance L and a lump capacitor C, the impedance transformation has a quality factor of

$$Q = \sqrt{\frac{L}{C}} . \qquad ( 4 )$$

The condition for impedance matching can then be described as

$$\frac{{Z}_{L}}{{Q}^{2}} < {Z}_{s} . \qquad ( 5 )$$

A high Q matching tolerates less design and simulation errors, while commodity surface mount components typically have a tolerance of about 5%. Therefore, the resonant frequency of the antenna may shift beyond the desired operating frequency for high Q matching due to component inaccuracy because

$$Q = \frac{Resonant peak frequency}{Bandwidth} . \qquad ( 6 )$$

Thus, there is a trade-off between impedance matching and frequency matching.

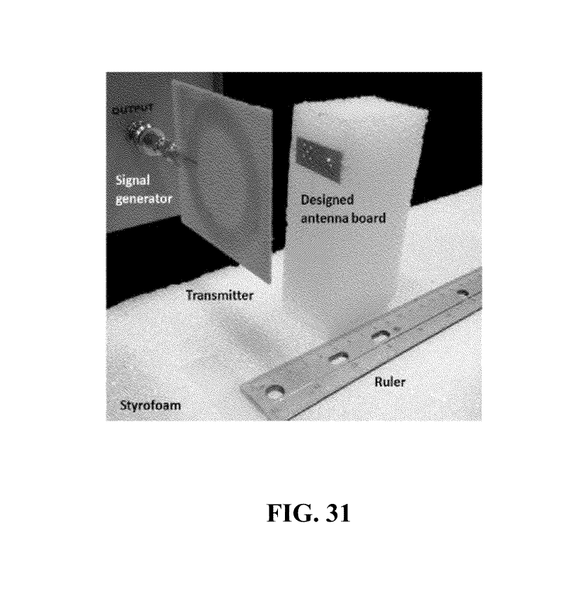

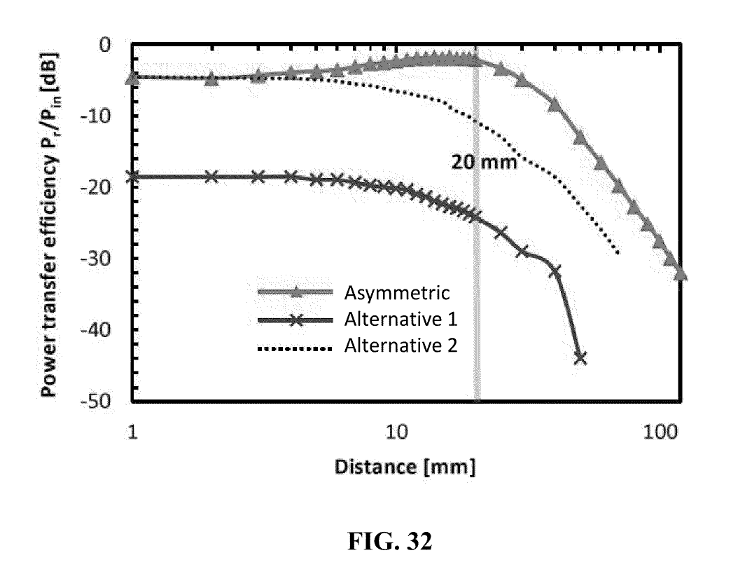

FIG. 31 illustrates an experimental setup for measuring antenna power transfer efficiency (PTE). The PTE is defined as

$$PTE = \frac{{P}_{r}}{{P}_{in}} , \qquad ( 7 )$$

where Pᵢₙ is the input power to the transmitter, and Pᵣ is the power received by the receiver, which is the LED turn-on power level (about 800 μW) in the experimental setup. FIG. 32 illustrates the measured PTEs as a function of the distance between the transmitter (charging station antenna) and the receiver antenna aligned at the centers of the antennas. The asymmetric dipole antenna has the highest power transfer efficiency at any distance, especially at 20 mm for which the matching circuit is designed. The measured PTE level also matches the performance of commercial wireless charging devices, such as LXWS10TTEA-014 from Murata Manufacturing Co., Ltd., which has PTEs of about 70% to 80%. In some embodiments, the PTE of an antenna can be about 30% or more, about 40% or more, about 50% or more, about 60% or more, about 70% or more, or about 80% or more.

The performances of the three different antenna designs are summarized in Table I. Among the three antenna designs, an asymmetric dipole antenna with a 3-turn loop is appropriate for the full board area (10×24 mm²), and an Alternative 2 antenna with a 4-turn loop is better for a smaller board area (10×6 mm²). However, a larger number of turns may increase the electromagnetic coupling between the NFC and the Bluetooth antennas, and therefore the Bluetooth antenna performance may be degraded.

TABLE I
Comparison of Antenna Performance

| | Radiation | | | | |
|---|---|---|---|---|---|
| | Efficiency | Maximum | | | |
| | at | Radiation | Max | Number | NFC Loop |
| | ~2.45 | Efficiency | PTE | of | Area |
| Antenna | GHz (%) | (%) | (%) | Turns | (mm²) |
| Asymmetric | 39 | 53 | 78 | 3 | 10 × 24 |
| Dipole | | | | | |
| Alternative 1 | 69 | 79 | 12 | 1 | 10 × 24 |
| Alternative 2 | 57 | 58 | 59 | 4 | 10 × 6 |

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

While certain conditions and criteria are specified herein, it should be understood that these conditions and criteria apply to some embodiments of the disclosure, and that these conditions and criteria can be relaxed or otherwise modified for other embodiments of the disclosure.

As used herein, the singular terms “a,” “an,” and “the” include plural referents unless the context clearly dictates otherwise. Thus, for example, reference to an object can include multiple objects unless the context clearly dictates otherwise.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, the terms can refer to less than or equal to ±5%, such as less than or equal to ±4%, less than or equal to ±3%, less than or equal to ±2%, less than or equal to ±1%, less than or equal to ±0.5%, less than or equal to ±0.1%, or less than or equal to ±0.05%

While the invention has been described with reference to the specific embodiments thereof, it should be understood by those skilled in the art that various changes may be made and equivalents may be substituted without departing from the true spirit and scope of the invention as defined by the appended claim(s). In addition, many modifications may be made to adapt a particular situation, material, composition of matter, method, operation or operations, to the objective, spirit and scope of the invention. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

1. A wearable device, comprising:
a base member configured for placement on a human subject;
a rechargeable battery affixed to the base member;
an electronic board affixed to the base member; and
a dual-band antenna printed on the electronic board for wireless power and data communication.

2. The device of claim 1, wherein the dual-band antenna is an asymmetric dipole antenna including a dipole arm and a loop connected to the dipole arm.

3. The device of claim 1, wherein the dual-band antenna comprises two monopole elements and a matching component connecting the two monopole elements.

4. The device of claim 1, wherein at least a part of the dual-band antenna is circumferential.

5. The device of claim 1, wherein the dual-band antenna is configured for both near field and far field communications.

6. The device of claim 1, wherein an operating frequency of a first band of the dual-band antenna is at least 100 times higher than an operating frequency of a second band of the dual-band antenna.

7. The device of claim 1, wherein a first band of the dual-band antenna is at least one of a Bluetooth and a Wi-Fi operating bands.

8. The device of claim 1, wherein a second band of the dual-band antenna is at least one of a near field communication and an inductive power transfer standard operating bands.

9. The device of claim 1, wherein the electronic board further comprises at least one sensor configured for motion measurement.

10. The device of claim 1, wherein the electronic board further comprises a circuit for indicating at least one of a power level, a vital sign, a temperature level, and an alarm signal.

11. The device of claim 1, wherein the electronic board further comprises:
a processor; and
a memory in electronic communication with the processor, the memory comprising program code configured to process sensor data.

12. The device of claim 1, wherein the electronic board and the rechargeable battery are hermetically sealed.

13. The device of claim 1, wherein the base member has a generally U-shaped form defining a channel to receive an upper or lower row of teeth of the human subject.

14. The device of claim 1, further comprising a daughter electronic board including a proximity sensor configured to measure a location of the device relative to the human subject.

15. The device of claim 1, further comprising a daughter electronic board including an additional antenna for at least one of wireless power and data communication.

16. A method of wirelessly powering a wearable device, comprising:
providing the wearable device, comprising
a base member configured for placement on a human body;
a rechargeable battery affixed to the base member;
an electronic board affixed to the base member; and
a dual-band antenna printed on the electronic board for wireless power and data communication;
providing a charging station for wireless communication with the wearable device, comprising:
a power source; and
an antenna configured to communicate with the wearable device;
transmitting wireless signals using the antenna on the charging station;
receiving the wireless signals using the dual-band antenna on the wearable device; and
charging the rechargeable battery on the wearable device with the wireless signals received.

17. The method of claim 16, wherein the charging station comprises at least one of a smartphone, a charging box, a wearable pack, a body garment, a helmet patch, a locker, and a mat on a sports field.

18. The method of claim 16, wherein the power source of eh charging station comprises at least one of a battery, an alternative current power supply, a universal serial bus device, a photovoltaic cell, a piezoelectric power generator, an electromagnetic power generator, a chemical battery using human saliva, a thermoelectric power generator, and an acoustic energy harvesting device.

19. The method of claim 16, wherein the antenna on the charging station is an antenna array

20. The method of claim 16, wherein the antenna on the charging station is matched with the dual-band antenna on the wearable device for power transfer.
